(19) United States
(12) Patent Application Publication
(10) Pub. No.: US 2020/0027160 A1
(43) Pub. Date: Jan. 23, 2020

(54) INFORMATION PROCESSING METHOD, INFORMATION PROCESSING APPARATUS AND PROGRAM

(71) Applicant: Mercari, Inc., Minato-ku (JP)

(72) Inventors: Keisuke Sogawa, Minato-ku (JP); Misato Takahashi, Minato-ku (JP); Keita Nakamura, Minato-ku (JP); Lan Do, Minato-ku (JP)

(21) Appl. No.: 16/512,994

(22) Filed: Jul. 16, 2019

(30) Foreign Application Priority Data
Jul. 17, 2018 (JP) 2018-134559

(51) Int. Cl. G06Q 40/04; G06F 3/0482

(52) U.S. Cl. CPC G06Q 40/04; G06F 2203/04803; G06F 3/0482

(57) ABSTRACT

An information processing method and like that enable removal of botheration a user has in a deposit/withdrawal operation and thereby enable a smooth buy/sell transaction of a transaction subject by the user are provided. The information processing method according to the present disclosure comprising: associating a user and a first account for the user to sell/buy a transaction subject; managing a sell/buy order of the transaction subject and a deposit in the first account; generating a buy order of the transaction subject based on an instruction from the user; and if a balance of the deposit has insufficiency for a price of the buy order, transferring a fund that is equal to or exceeds the balance insufficiency, from one or more second accounts that are different from the first account and associated with the user to the first account, based on an approval from the user.

### BACKGROUND OF THE INVENTION

### Field of the Invention

The present disclosure relates to an information processing method, an information processor and a program.

### Description of the Related Art

Conventionally, services that enable users (investors) to make buy/sell transactions of virtual currencies and various financial instruments online via a network, using a terminal such as a computer having a communication function, a smartphone, a tablet or a mobile phone have generally and widely been used. As an example of such services, for example, Japanese Patent Laid-Open No. 2017-120666 describes a financial instrument transaction manager for continuously performing financial instrument transactions and management of the transactions according to quotation price fluctuations.

### Problem 1

As stated above, in general, an online financial instrument transaction requires a user to open a transaction account with a securities house or a service provider. The user needs to deposit a fund from a financial account of a financial institution into the transaction account. The user can buy (purchase) a financial instrument within the scope of the amount of the fund deposited. Further, the user can appropriate proceeds of selling of a financial instrument as a deposit in the transaction account and manage the deposit. Moreover, the user, as necessary, can withdraw a part or all of the deposit from the transaction account to the financial account.

Each time deposit/withdrawal processing is performed between the financial account and the transaction account, normally, the user's operation and confirmation work for the deposit/withdrawal is needed. For example, in the case of depositing a fund from the financial account into the transaction account, the user needs to visit a physical office or an automated teller machine (ATM) of the financial institution or perform online processing such as Internet banking. Then, the user makes a transfer of the fund from the financial account to the transaction account (in reality, another deposit-only financial account, a number of which is issued in association with the transaction account). Also, an online service that enables real-time deposit processing is sometimes provided. However, even in such case, the user needs to access the financial account and perform an operation with a plurality of steps for the transfer.

However, a deposit/withdrawal operation necessary for such conventional buy/sell transaction takes a lot of trouble and thus is very bothersome for the user. As a result, a smooth buy/sell transaction is impaired, causing the problem of reducing the user's willingness for a buy/sell transaction or the user missing a chance for a buy/sell transaction.

Therefore, an aspect of the present disclosure has been made in view of such circumstances. An object of the aspect is to provide an information processing method, an information processor and a non-transitory computer-readable medium recording a program that enable removal of botheration a user has in a deposit/withdrawal operation (in particular, a deposit operation). The aspect of the present disclosure thereby enables a smooth buy/sell transaction of a transaction subject by the user.

### Problem 2

Also, as stated above, in general, an online financial instrument transaction requires a user to open a transaction account with a securities house or a service provider. The user needs to deposit a fund from a financial account of a financial institution into the transaction account. The user can buy (purchase) a financial instrument within the scope of the amount of the fund deposited. Further, the user can appropriate proceeds of selling of a financial instrument as a deposit in the transaction account and manage the deposit. Moreover, the user, as necessary, can withdraw a part or all of the deposit from the transaction account to the financial account.

Each time deposit/withdrawal processing is performed between the financial account and the transaction account, normally, the user's operation or confirmation work for the deposit/withdrawal is needed. For example, in the case of depositing a fund from the transaction account into the financial account, the user needs to access a transaction service of a securities house or a service provider. The user needs to execute a menu item for withdrawal from the transaction account and then perform an operation with a plurality of steps for the withdrawal, the plurality of steps including confirmation of a withdrawal destination financial account.

However, a deposit/withdrawal operation necessary for such conventional buy/sell transaction takes a lot of trouble and thus is very bothersome for the user. As a result, convenience of the transaction service is impaired, causing the problem of reducing the user's willingness for a buy/sell transaction or lowering a frequency of use of the transaction service by the user and finally leaving from the transaction service.

Therefore, an aspect of the present disclosure has been made in view of such circumstances. An object of the aspect is to provide an information processing method, an information processor and a non-transitory computer-readable medium recording a program that enable removal of botheration a user has in a deposit/withdrawal operation (in particular, a withdrawal operation) to enhance convenience of a transaction service. The aspect of the present disclosure thereby enables enhancement in quality of the service for the user.

### Problem 3

As stated above, in general, an online financial instrument transaction requires a user to open a transaction account with a securities house or a service provider. In conventional buy/sell transactions, only one transaction account can be used in one buy/sell transaction. However, the user needs to deposit a fund from a financial account of a financial institution into the transaction account prior to a transaction and buy (purchase) a financial instrument within the scope of the amount of the fund deposited. Furthermore, the user appropriates proceeds of selling of a financial instrument as a deposit in the transaction account and manages the deposit. Moreover, the user, as necessary, can withdraw a part or all of the deposit from the transaction account to the financial account.

However, a deposit/withdrawal operation necessary for such conventional buy/sell transaction takes a lot of trouble and thus is very bothersome for the user. As a result, a smooth buy/sell transaction is impaired, causing the problem of reducing the user's willingness for a buy/sell transaction or the user missing a chance for a buy/sell transaction.

Therefore, an aspect of the present disclosure has been made in view of such circumstances. An object of the aspect is to provide an information processing method, an information processor and a non-transitory computer-readable medium recording a program that enable removal of botheration a user has in a deposit/withdrawal operation (in particular, a deposit operation). The aspect of the present disclosure thereby enables a smooth buy/sell transaction of a transaction subject by the user.

### SUMMARY OF THE INVENTION

### Solution 1

An information processing method according to an embodiment of the present disclosure is an information processing method for an information processor, the method comprising: associating a user and a first account for the user to sell/buy a transaction subject; managing a sell/buy order of the transaction subject and a deposit in the first account; generating a buy order of the transaction subject based on an instruction from the user; and if a balance of the deposit has insufficiency for the buy order, transferring a fund that is equal to or exceeds the insufficiency, from one or more second accounts that are different from the first account and associated with the user to the first account, based on an approval from the user.

### Solution 2

An information processing method according to an embodiment of the present disclosure is an information processing method for an information processor, the method comprising: associating a user and a first account for the user to buy/sell a transaction subject; managing a buy/sell order of the transaction subject and a deposit in the first account; and transferring a part or all of the deposit from the first account to one or more second accounts that are different from the first account and associated with the user, based on an approval from the user.

### Solution 3

A non-transitory computer-readable medium recording a program according to an embodiment of the present disclosure causes an information processing terminal to perform: displaying a transaction amount designated object with a transaction amount upper limit of a transaction subject as an upper limit of a designation range, the transaction amount upper limit being determined based on a balance of a first account and a balance of a second account; displaying a transaction amount responding to an instruction for the transaction amount designated object from a user; if a transaction amount that is smaller than a predetermined transaction amount is designated, displaying only a first display area associated with the first account; and if a transaction amount that is larger than the predetermined transaction amount is designated, displaying both the first display area associated with the first account and a second display area associated with the second account.

### BRIEF DESCRIPTION OF THE DRAWINGS

FIG. 1 illustrates a configuration of a telecommunication system according to an aspect of an embodiment;

FIG. 2 illustrates an example of a hardware configuration of an information processor according to the present disclosure;

FIG. 3 is a diagram schematically illustrating an overview of a first embodiment;

FIG. 4 illustrates an example of a block diagram illustrating functional configurations of information processors according to the first embodiment;

FIG. 5 illustrates an example of a flowchart of processing in information processors according to the first embodiment;

FIGS. 6A to 6C illustrate an example of transition of screens displayed on a terminal in the processing in the information processors according to the first embodiment;

FIG. 7 conceptually illustrates a part of a processing flow in an information processor according to the first embodiment;

FIG. 8 conceptually illustrates an example of a processing flow in an information processor according to each of first to fourth examples of the first embodiment;

FIG. 9 conceptually illustrates an example of a processing flow in an information processor according to a fifth example of the first embodiment;

FIG. 10 conceptually illustrates an example of a processing flow in an information processor according to a sixth example of the first embodiment;

FIG. 11 conceptually illustrates an example of a processing flow in an information processor according to a seventh example of the first embodiment;

FIG. 12 illustrates an example of a flowchart of processing in information processors according to an eighth example of the first embodiment;

FIG. 13 illustrates an example of a flowchart of processing in information processors according to a ninth example of the first embodiment;

FIG. 14 illustrates an example of a flowchart of processing in information processors according to a tenth example of the first embodiment;

FIGS. 15A and 15B are diagrams schematically illustrating an overview of a second embodiment;

FIG. 16 illustrates an example of a flowchart of processing in information processors according to the second embodiment;

FIGS. 17A to 17C illustrate an example of transition of screens displayed on a terminal in the processing in the information processors according to the second embodiment;

FIG. 18 conceptually illustrates an example of a processing flow in an information processor according to the second embodiment;

FIG. 19 illustrates an example of a flowchart of processing in information processors according to a first example of the second embodiment;

FIG. 20 illustrates an example of a flowchart of processing in information processors according to a second example of the second embodiment;

FIG. 21 illustrates an example of a flowchart of processing in information processors according to a third example of the second embodiment;

FIG. 22 illustrates an example of a flowchart of processing in information processors according to a fourth example of the second embodiment;

FIG. 23 illustrates an example of a flowchart of processing in information processors according to a fifth example of the second embodiment;

FIG. 24 illustrates an example of a processing sequence in an electro transaction system according to a third embodiment;

FIGS. 25A to 25C illustrate an example of transition of screens displayed on a terminal in processing in information processors according to the third embodiment;

FIG. 26 illustrates an example of a screen displayed on a terminal in the processing in the information processors according to a first example of the third embodiment;

FIG. 27 illustrates an example of a screen displayed on a terminal in the processing in the information processors according to a second example of the third embodiment;

FIG. 28 illustrates an example of a processing sequence in an electro transaction system according to a fourth embodiment; and

FIGS. 29A to 29C illustrate an example of a screen displayed on a terminal in processing in information processors according to the fourth embodiment.

### DETAILED DESCRIPTION OF THE PREFERRED EMBODIMENTS

### <Legal Compliance>

Where the disclosure of the present specification is practiced, the practice is performed in compliance with the laws and regulations for practicing the present disclosure in the relevant country. Furthermore, the disclosure of the present specification is practiced with all changes, replacements, modifications, alterations and amendments that a person skilled in the art can make and are necessary for compliance with the laws and regulations in the relevant country.

A mode for practicing an information processing method, an information processor and a non-transitory computer-readable medium recording a program according to the present disclosure will be described with reference to the drawings.

### <System Configuration>

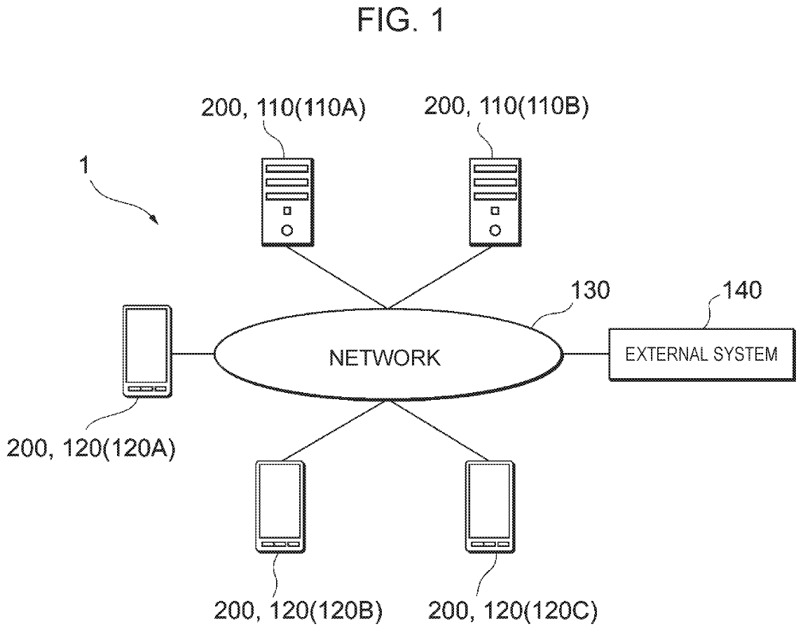

FIG. 1 illustrates a configuration of a telecommunication system 1 for effectively practicing an information processing method according to an embodiment of the present disclosure. As disclosed in FIG. 1, in the telecommunication system 1, a server 110A and a server 110B, a terminal 120A, a terminal 120B and a terminal 120C, and an external system 140 built by, e.g., a server that is different from the servers 110A and 110B, the server being administered by, for example, another business entity (third party) or another business department, are connected via a network 130.

In the present disclosure, where there is no need to distinguish the server 110A and the server 110B from each other, each of the server 110A and the server 110B may be referred to as “server 110”.

In the present disclosure, where there is no need to distinguish the terminal 120A, the terminal 120B and the terminal 120C from one another, each of the terminal 120A, the terminal 120B and the terminal 120C may be referred to as “terminal 120”.

In the present disclosure, where there is no need to distinguish the servers 110 and the terminals 120 from each other, each of the servers 110 and the terminals 120 may be referred to as “information processor 200”. Note that the number of information processors 200 and the number of external systems 140 connected to the network 130 are not limited.

Each server 110 provides a predetermined service to the terminals 120 used by respective users via the network 130. Examples of the predetermined service includes, but not limited to, settlement services, electronic transaction services, SNSs (social networking services) represented by instant messengers, and content providing services for music, videos, books, etc. The server 110 can provide the predetermined service to one or more terminals 120 by use of the predetermined service by each user via his/her terminal 120.

As necessary, a terminal used by a user X is referred to as “terminal 120X” and user information associated with the user X or the terminal 120X in the predetermined service is referred to as “user information X”. Note that user information is user information associated with an account used by a user in the predetermined service. Examples of the user information includes, but not limited to, pieces of information associated with the user such as a name of the user, an icon image of the user, an age of the user, a gender of the user, an address of the user, likes and tastes of the user and an identifier of the user, which are input by the user or provided by the predetermined service. The user information may be any one of the above or any combination of the above.

The network 130 assumes the role of connecting two or more information processors 200. The network 130 means a communication network that provides a communication channel that enables transmission/reception of data after connection of a terminal 120 to a server 110.

Each of one or more parts of the network 130 may be a wired network or a wireless network. Examples of the network 130 can include, but not limited to, ad hoc networks, intranets, extranets, virtual private networks (VPN), local area networks (LAN), wireless LANs (WLANs), wide area networks (WANs), wireless WANs (WWANs), metropolitan area networks (MANs), a part of the Internet, a part of public switched telephone networks (PSTNs), mobile telephone networks, ISDNs (Integrated Service Digital Networks), wireless LANs, LTE (Long-Term Evolution), CDMA (code-division multiple access), Bluetooth (registered trademark) and satellite communication, or a combination of two or more thereof. The network 130 can include one or more networks 130.

Each information processor 200 may be any information processor as long as the information processor can implement execution processes and/or methods described in the present disclosure. Examples of the information processor 200 include, but not limited to, smartphones, mobile phones (feature phones), computers (examples of which include, but not limited to, desktops, laptops and tablets), server apparatuses, media computer platforms (examples of which include, but not limited to, cables, satellite set-top boxes and digital video recorders), hand-held computer (examples of which include, but not limited to, PDAs (personal digital assistants), e-mail clients), wearable terminals (examples of which include, but not limited to, glasses-like devices and watch-like devices) and other types of computers or communication platforms.

### <Hardware (HW) Configuration>

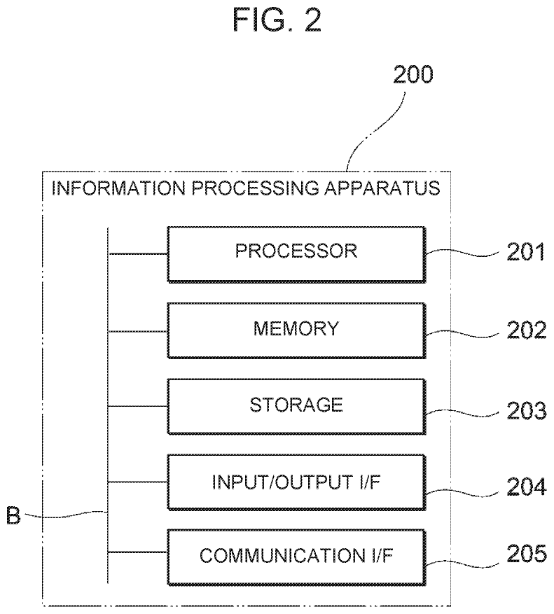

An HW configuration of an information processor 200 included in the telecommunication system 1 will be described with reference to FIG. 2.

The information processor 200 includes a processor 201, a memory 202, a storage 203, an input/output interface (input/output I/F) 204 and a communication interface (communication I/F) 205. The components of the HW of the information processor 200 are interconnected via, for example, but not limited to, a bus B.

The information processor 200 implements execution processes and/or methods described in the present disclosure by means of cooperation among the processor 201, the memory 202, the storage 203, the input/output I/F 204 and the communication I/F 205.

The processor 201 executes functions and methods implemented according to respective codes or instructions included in programs stored in the storage 203. Examples of the processor 201 include, but not limited to, central processing units (CPUs), MPUs (micro processing units), GPUs (graphics processing units), microprocessors, processor cores, multiprocessors, ASICs (application-specific integrated circuits) and FPGAs (field-programmable gate arrays), and the processor 201 may implement each step of processing disclosed in each of the embodiments via a logical circuit (hardware) or a dedicated circuit formed in, e.g., an integrated circuit (IC (integrated circuit) chip or an LSI (large-scale integration)). Furthermore, each of these circuits may be provided by one or more integrated circuits and plural steps of processing indicated in each embodiment may be implemented by a single integrated circuit. Also, an LSI may be referred to as, e.g., a VLSI, a super LSI, or an ultra LSI, depending on the degree of integration.

The memory 202 temporarily stores a program loaded from the storage 203 and provides a work area for the processor 201. In the memory 202, various data generated during execution of the program by the processor 201 are temporarily stored. Examples of the memory 202 include, but not limited to, RAMs (random access memories) and ROMs (read-only memories).

The storage 203 stores programs. Examples of the storage 203 include, but not limited to, HDDs (hard disk drives), SSDs (solid-state drives) and flash memories.

The communication I/F 205 performs transmission/reception of various data via the network 130. Such communication may be performed via a wire or wirelessly and any communication protocol may be used as long as mutual communication is possible. The communication I/F 205 has a function that performs communication with another information processor via the network 130. The communication I/F 205 transmits various data to the information processor according to an instruction from the processor 201. Also, the communication I/F 205 receives various data transmitted from the other information processor and conveys the data to the processor 201.

The input/output I/F 204 includes an input section for inputting various instructions to the information processor 200 and an output section for outputting a result of processing in the information processor 200. In the input/output I/F 204, the input section and the output section may be integrated with each other or may be separated from each other.

The input section is implemented by any of all kinds of devices that can receive an input from a user and convey information relating to the input to the processor 201 or a combination of such devices. Examples of the input section include, but not limited to, touch panels, touch displays, hardware keys such as keyboards, pointing devices such as mouses, cameras (for an input of an instruction via an image) and microphones (for an input of an instruction via voice).

The output section is implemented by any of all kinds of devices that can output a processing result of processing in the processor 201 or any combination of the devices. Where the processing result is output as a picture image and/or a moving image, the output section is implemented by any of all kinds of devices that can display data written in a frame buffer according to the display data or any combination of the devices. Examples of the output section include, but not limited to, touch panels, touch displays, monitors (examples of which include, but not limited to, liquid-crystal displays and OELDs (organic electroluminescence displays)), head-mounted displays (HDMs), display devices that can display, e.g., an image or text information in, e.g., the air (may be vacuum) such as projection mapping or a hologram, speakers (sound output) and printers. Note that each of these output devices may be one that can display data in 3D.

A program in each embodiment of the present disclosure may be provided in a state in which the program is stored in a computer-readable recording medium. The recording medium enables the program to be stored on a “non-transitory tangible medium”. Examples of the program include, but not limited to, software programs and computer programs.

Where appropriate, the recording medium can include one or more semiconductor-based or other-type integrated circuits (ICs) (examples of which include, but not limited to, field-programmable gate arrays (FPGAs) and application-specific ICs (ASICs)), hard disk drives (HDD), hybrid hard drives (HHDs), optical disks, optical disk drives (ODDs), magnetooptical disks, magnetooptical drives, floppy diskettes, floppy disk drives (FDDs), magnetic tapes, solid-state drives (SSDs), RAM drives, secure digital cards or drives and other arbitrary appropriate recording mediums or a proper combination of two or more thereof. Where appropriate, the recording medium may be volatile, non-volatile or a combination of volatile and non-volatile recording mediums.

Also, a program according to the present disclosure may be provided to the information processor 200 via an arbitrary transmission medium that can transmit the program (e.g., a communication network or broadcast wave). Also, in each embodiment of the present disclosure, a program can be provided in the form of a data signal embedded in a carrier wave, the data signal being realized by electronic transmission.

Note that examples of the program according to the present disclosure include, but not limited to, ones provided using languages, examples of which include, but not limited to, scripting languages such as ActionScript and JavaScript (registered trademark), object-oriented programming languages such as Objective-C and Java (registered trademark) and markup languages such as HTML5.

At least a part of processing in the information processor 200 is implemented by means of cloud computing including one or more computers.

A configuration in which at least a part of processing in the information processor 200 is performed by another information processor may be employed. In this case, at least a part of processing in functional sections implemented by the processor 201 may be performed by another information processor.

### <Others>

Unless clearly stated otherwise, a configuration for determination in each of the embodiments of the present disclosure is not essential, and predetermined processing may be performed if a determination condition is met or predetermined processing may be performed if a determination condition is not met.

In the present disclosure, unless otherwise clearly stated or unless otherwise indicated by the context, “or” has a meaning of not exclusion but inclusion. Therefore, in the present disclosure, unless otherwise clearly stated or unless otherwise indicated by the context, “A or B” means “A or B or both of A and B”. Furthermore, unless otherwise clearly stated or unless otherwise indicated by the context, “and” has a meaning of both “joint” and “several”. Therefore, in the present specification, unless otherwise clearly stated or unless otherwise indicated by the context, “A and B” means “A and B, jointly or severally”. Furthermore, unless otherwise clearly stated or unless otherwise indicated by the context, “a”, “an” or “the” means “one or more”. Therefore, in the present specification, unless otherwise clearly stated or unless otherwise indicated by the context, “an A” or “the A” means “one or more As”.

The present disclosure includes all of changes, replacements, modifications, alterations and amendments a person skilled in the art can make to the embodiments of the present disclosure and/or the examples thereof. Likewise, as appropriate, the accompanying claims include all of changes, replacements, modifications, alterations and amendments a person skilled in the art can make to the embodiments of the present disclosure and/or the examples thereof. Furthermore, the present disclosure includes an arbitrary combination of one or more features of an embodiment of the present disclosure and/or the examples thereof and one or more features of another embodiment of the present disclosure and/or the examples thereof, that a person skilled in the art can make.

In addition, reference to an apparatus or system adapted, disposed, capable, configured, usable, operable or capable of operating to perform a particular function and components of such apparatus or system in the accompanying claims includes the apparatus or the system and the component thereof regardless of whether or not the apparatus or the system, the components or the particular function is activated, turned on or unlocked, as long as the apparatus, the system or the components are adapted, disposed, capable, configured, useable, operable or capable of operating to perform so.

Embodiments according to an example of the present disclosure will be described below with reference to the drawings. However, the below-described embodiments are mere examples and are not intended to exclude various alterations and technical applications not clearly indicated below. In other words, various alterations of the example of the present disclosure are possible without departing from the spirit of the present disclosure. Also, in the below description of the drawings, parts that are identical or similar to each other are provided with a same or similar reference numeral, and the drawings are schematic ones and do not necessarily correspond to actual dimensions, ratios and the like. Furthermore, the drawings may include respective parts that are different in dimensional relationship or ratio from each other.

### First Embodiment

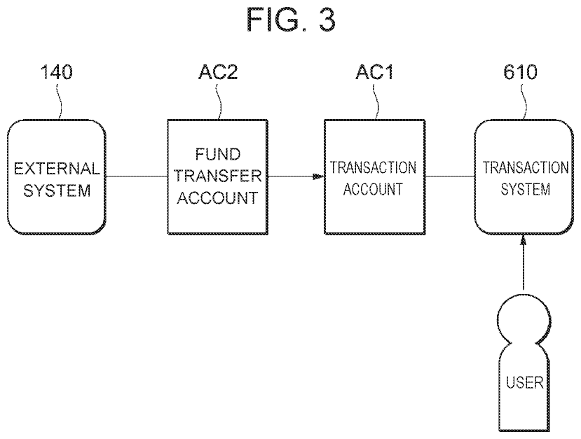

A first embodiment is an embodiment indicating an example of application of the present disclosure to a service that allows a user to make a buy/sell transaction of a transaction subject online via the network 130, using a terminal 120. FIG. 3 is a diagram schematically illustrating an overview of the first embodiment. In the first embodiment, for example, an electro transaction system 610 for making a buy/sell transaction of a transaction subject is built by a server 110. A user transmits a desired buy/sell order to the electro transaction system 610 from a terminal 120 through the network 130. The electro transaction system 610 places the buy/sell order with a predetermined exchange and establishes an agreement of buying and selling of the transaction subject. Also, in order to use the service provided by the electro transaction system 610, a transaction account AC1 is opened for each user. The user can use a deposit in the transaction account AC1 for payment of the buy order of the transaction subject. Furthermore, in placing a buy order, if a balance of the deposit in the transaction account AC1 is insufficient for the buy order, based on the user's approval on the electro transaction system 610, a fund can be transferred from a fund transfer account AC2 that is different from the transaction account AC1 to the transaction account AC1 and the fund can be appropriated for the payment. The fund transfer account AC2 is an account that is different from the transaction account AC1, which is a withdrawal source account for the electro transaction system 610. Also, a fund from an external system 140 such as a financial institution can appropriately be appropriated to the fund transfer account AC2.

### Effects of the First Embodiment

According to the first embodiment, the trouble of a deposit/withdrawal operation needed in a conventional transaction system that performs a buy/sell transaction can be reduced, enabling removal of botheration a user conventionally has in a deposit/withdrawal operation (in particular, a deposit operation). Thus, a smooth buy/sell transaction of a transaction subject can be conducted. In other words, according to the first embodiment, a conventional procedure or operation necessary for transfer of money between a transaction account and a financial account can be reduced, enabling a buy/sell transaction of a transaction subject to be made “smoothly” by a seamless operation in an electro transaction system. As a result, the number of operations by a user is decreased and stress is thus reduced, enabling enhancement in user convenience. Also, the user's willingness for a buy/sell transaction can be maintained. Furthermore, the user can make a buy/sell transaction at a desired timing without missing a chance for the transaction.

Note that “transaction subject” in the present disclosure indicates a virtual currency or any of various financial instruments. In principle, “virtual currency” includes the items set forth in Articles 2 (5)(i) and 2 (5)(ii) of Payment Services Act (Act No. 59 of 2009) of Japan and items that are equivalent thereto. The items are circulated only in the form of electronic data rather than cash such as banknotes and coins. Also, the items are usable as a consideration for goods or a service among many and unspecified people through a network. Further, the items are bought/sold at a specialized exchange or dealer with no existence of an official issuance entity or manager such as a central bank, or being exchangeable with a substantive currency such as yen, dollar or Euro. Also, “financial instrument” includes, e.g., general negotiable instruments and derivative financial instruments (financial derivatives). Examples of “financial instrument” include, but not limited to, shares, bonds, real estate securities, investment trusts, convertible bonds, margin trading, domestic bonds, foreign bonds, MMF, medium-term government securities funds, MRF, REIT, CFD, ETF, ETN, foreign exchange, gold, platinum, commodity futures, various time deposits, various structured deposits, various savings, various insurances, money trusts, foreign currency deposits and the like, futures trading, options, swapping and share options. Also, each of the embodiments and the examples disclosed below will be described in terms of a case where a buy/sell transaction of a virtual currency, which is a transaction subject, is made, the scope of application of the present disclosure is not limited to buy/sell transactions of virtual currencies. In other words, the present disclosure can be applied if an account used for transactions and an account that holds a fund are provided separately.

### Configuration of the First Embodiment

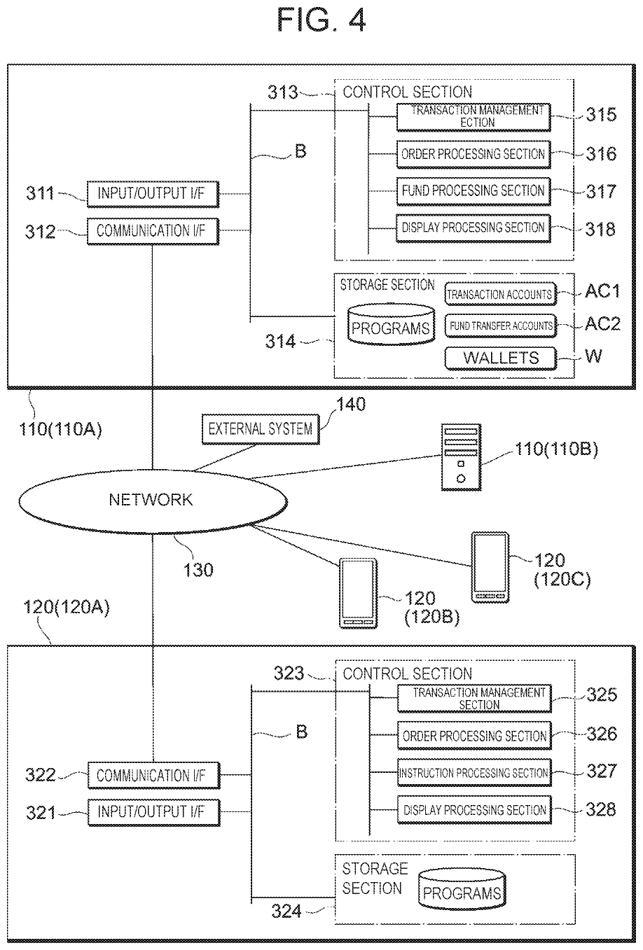

A Configurations of a server 110 and/or a terminal 120 will be described with reference to FIG. 3. FIG. 4 illustrates an example of a block diagram illustrating configurations of information processors according to the first embodiment and is a diagram illustrating a schematic overall configuration of an electro transaction system built by the information processors 200 (the server 110 and the terminal 120). The sections disclosed in FIG. 4 are implemented by means of cooperation among the processor 201, the memory 202, the storage 203, the input/output I/F 204 and the communication I/F 205 included in each information processor 200. In other words, the processor 201 of the information processor 200 illustrated in FIG. 2 loads various programs (e.g., a control program and an arithmetic program) stored in the storage 203 into the memory 202 (for example, a RAM). Then, the processor 201 interprets and executes various programs loaded in the memory 202 to control the respective hardware components, whereby the below-described configuration is implemented.

Note that the sections implemented by the information processor 200 may be implemented by the processor 201 such as a general-purpose CPU or a part or all of the sections may be implemented by one or more dedicated processors 201. Furthermore, it is a matter of course that the configuration implemented by the information processor 200 may appropriately be subjected to omission, replacement and addition of sections according to the embodiment or the example.

### (1) Configuration of the Server

The server 110 includes an input/output I/F 311, a communication I/F 312, a control section 313 and a storage section 314. The input/output I/F 311 corresponds to the input/output I/F 204 in FIG. 2 and the communication I/F 312 corresponds to the communication I/F 205 in FIG. 2. Also, the control section 313 includes a transaction management section 315, an order processing section 316, a fund processing section 317 and a display processing section 318.

In the server 110, upon execution of a virtual currency transaction system program stored in the storage section 314 by the processor 201, an electro transaction system for making a virtual currency buy/sell transaction is built. Prior to use of the electro transaction system, a user needs to open a his/her own transaction account (user account) AC1 for dealing with buying/selling of virtual currency in advance. The storage section 314 of the server 110 holds information on a deposit (held money) in the transaction account AC1 for each user (in association with relevant user information X). As described above, the transaction account AC1 corresponds to an example of the “first account” in the present disclosure.

Also, for each user, the storage section 314 holds information on a fund (held money) in one or more fund transfer accounts AC2 held by the user or provided for the user separately from the transaction account AC1. Each fund transfer account AC2 is an account that is not directly used for buying/selling of virtual currency by the electro transaction system. Also, each fund transfer account AC2 is different from the transaction account AC1, and as described below, is used for supplementing a fund necessary for a transaction according to a balance of the transaction account AC1. As described above, the fund transfer account AC2 corresponds to an example of the “second account” in the present disclosure. Furthermore, for each user and each kind of virtual currency, the storage section 314 holds information on an amount of virtual currency held by the user in what is called a wallet W, which is means for storing virtual currency.

Here, the fund transfer account AC2 may be provided in the server 110 or may be provided in a server that operates the particular external system 140. In the former case, for example, the fund transfer account AC2 may be provided in a service that manages the transaction account AC1 (virtual currency buying/selling system) and managed equally with the transaction account AC1. In the latter case, for example, the server 110 may acquire information on the fund in the fund transfer account AC2 from the particular external system 140 via the network 130 and hold the information in the storage section 314. Also, the wallet W may be a wallet classified into any of a web (online) wallet, a software (desktop) wallet, a hardware wallet and a cold (paper) wallet. Except a case where the wallet W is a web wallet (for example, an exchange wallet), for example, the server 110 may acquire information on an amount held in the wallet W via the network 130 and hold the information in the storage section 314.

The transaction management section 315 of the control section 313 in the server 110 performs management of various setting parameters and arithmetic parameters necessary for virtual currency buy/sell transactions performed by the electro transaction system. Further, the transaction management section 315 controls of various setting processing and arithmetic processing based on input parameters input by users. Moreover, the transaction management section 315 performs management of various pieces of information including, e.g., information relating to users' orders, information relating to execution of each order and an agreement for the order, information relating to funds (the deposit information for each transaction account AC1 and the fund information for each fund transfer account AC2 held in the storage section 314 and information on the amount of virtual currency held in each wallet W). Also, the order processing section 316 performs processing based on a buy/sell order placed by a user, the order being transmitted from the relevant terminal 120. Furthermore, the fund processing section 317 performs adjustment processing for buying/selling of virtual currency or deposit/withdrawal of fund. Also, the display processing section 318 generates image data of an image to be displayed on the input/output I/F 321 (output section) of a terminal 120 used by a user in various settings or various types of processing in the electro transaction system.

### (2) Configuration of the Terminal

The terminal 120 includes an input/output I/F 321, a communication I/F 322, a control section 323 and a storage section 324. The input/output I/F 321 corresponds to the “input/output I/F 204” in FIG. 2 and the communication I/F 322 corresponds to the “communication I/F 205” in FIG. 2. Also, the control section 323 includes a transaction management section 325, an order processing section 326, an instruction processing section 327 and a display processing section 328.

In the terminal 120, an electro transaction system application (program) stored in the storage section 324 is executed by the processor 201, enabling the user to access the virtual currency transaction system built by the server 110 and use the service. The transaction management section 325 of the control section 323 in the terminal 120 performs management of parameters input by the user, the parameters being necessary for virtual currency buy/sell transactions made in the electro transaction system. Further, the transaction management section 325 controls of various types of setting processing and various types of arithmetic processing in the terminal 120. Also, the order processing section 326 performs processing relating to a buy/sell order to be transmitted to the server 110, the order being placed by the user. Furthermore, the instruction processing section 327 performs processing relating to an instruction provided by the user other than the buy/sell order to be transmitted to the server 110. Also, the display processing section 328, based on image data transmitted from the server 110, provides display of an image (UI) for any of various types of settings and various types of processing in the electro transaction system on the input/output I/F 321 (output section) of the terminal 120.

### Operation and Processing in the First Embodiment

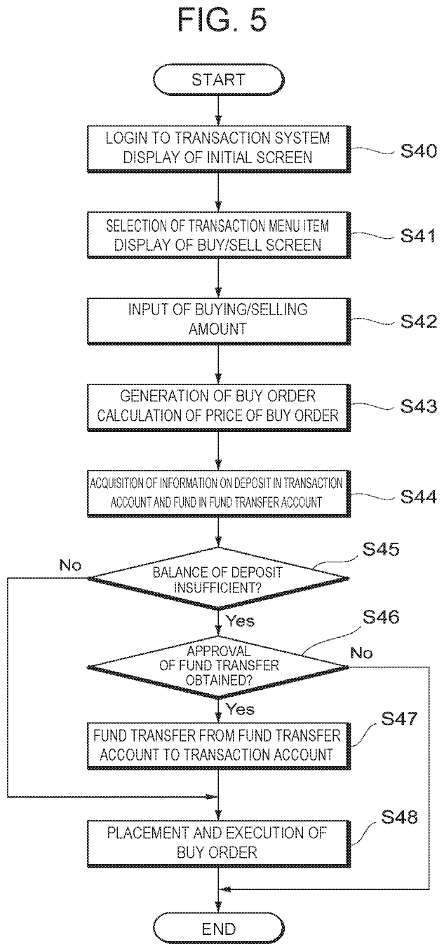

Processing in information processors according to the first embodiment will be described with reference to FIGS. 5 to 7. FIG. 5 illustrates an example of a flowchart of processing in information processors according to the first embodiment. FIG. 5 also indicates a flow illustrating an example of a processing procedure in an information processing method according to the present disclosure. Note that the below-described processing procedure is a mere example and each of the steps of processing may be changed as long as such change is possible within the scope of the technical idea of the present disclosure and appropriate omission, replacement and addition of steps are possible.

### (Step S40)

First, upon the user starting up the terminal 120 and executing an electro transaction system application (program), a login screen for login to the electro transaction system is displayed on the input/output I/F 321 of the terminal 120. In step S40, upon the user inputting his/her own login information from the input/output I/F 321 (input section), the instruction processing section 327 transmits the information to the server 110. If the login information is correct, the transaction management section 315 of the server 110 permits the user's login and transmits image data of an initial screen generated by the display processing section 318 to the terminal 120. The display processing section 328 of the terminal 120 provides display of the initial screen on the input/output I/F 321 (output section) based on the image data.

The initial screen is not specifically limited and examples of the initial screen can include, e.g., a particular screen provided as a default, a screen for various settings, a screen for information on a transaction account AC1, a screen for information on a fund transfer account AC2, a screen for information on a wallet W, a menu selection screen, a screen for information relating to virtual currency (e.g., transaction prices, a chart and a board), a virtual currency list (selection) screen, a screen for a specific virtual currency transaction, a screen displayed at the time of the user's last login, a screen customized by the user and a screen that is any combination of these screens. Note that as described above, the transaction account AC1 and a deposit in the transaction account AC1 and the fund transfer account AC2 and the fund in the fund transfer account AC2 are associated with relevant user information X. The transaction management section 315 and the fund processing section 317 of the server 110 manages buy/sell orders of virtual currency placed by the user and the deposit in the transaction account AC1 and the fund in the fund transfer account AC2. As described above, the transaction management section 315 and the fund processing section 317 correspond to respective examples of the “account management section” and the “deposit management section” in the present disclosure.

### (Step S41)

Next, in step S41, upon the user selecting a desired virtual currency transaction menu item on the initial screen (for example, the menu selection screen), the instruction processing section 327 transmits an instruction of the selection to the server 110. Based on the instruction of the selection, the transaction management section 315 and the display processing section 318 of the server 110 generate image data of a screen for buying/selling the virtual currency designated by the user and transmits the image data to the terminal 120. Based on the image data, the display processing section 328 of the terminal 120 provides display of a buy/sell screen for the virtual currency on the input/output I/F 321 (output section).

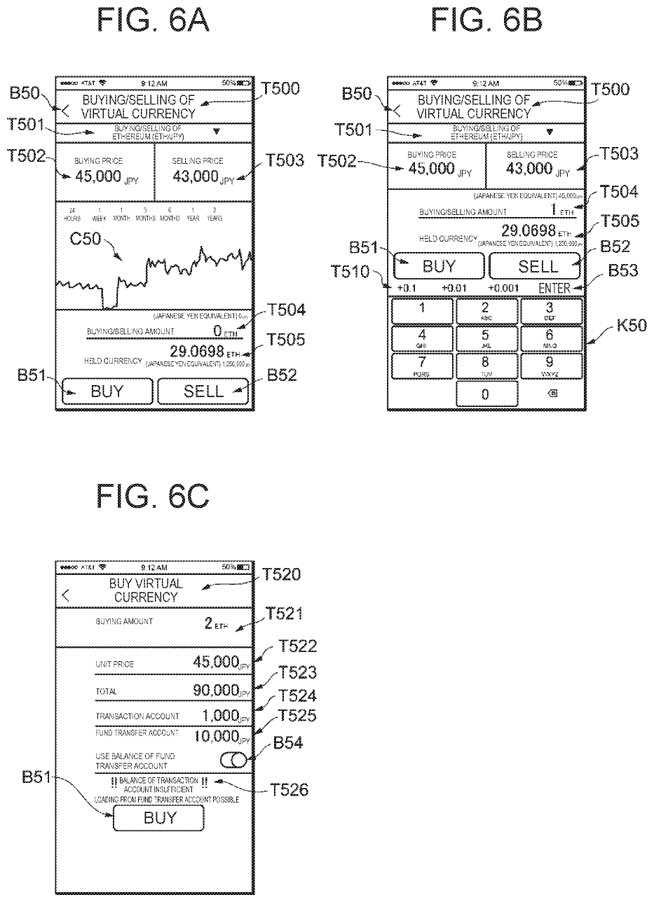

Here, FIGS. 6A to 6C illustrate an example of transition of screens displayed on a terminal 120 in the processing in the information processors according to the first embodiment. In step S41, in response to an instruction of the selection of the transaction menu item from the user, first, for example, the screen illustrated in FIG. 6A is displayed on the terminal 120. The display processing section 328 provides display of a text T500 indicating that the selected menu item is a menu item for buying/selling of virtual currency, a button B50 for returning to a previous menu, a text T501 indicating a kind of the selected virtual currency, a text T502 indicating a current unit buying price, a text T503 indicating a current unit selling price, a chart C50 indicating chronological transition of a price of the selected virtual currency (the period of the chart can be changed), a text T504 indicating a buying/selling amount of the virtual currency and a Japanese yen equivalent amount for the amount, a text T505 indicating an amount of the selected virtual currency held by the user and a Japanese yen equivalent amount for the amount, a button B51 for selecting buying of the virtual currency and a button B52 for selecting selling of the virtual currency, in the order from the upper part to the lower part of the screen illustrated in FIG. 6A.

### (Step S42)

Next, in step S42, the user wishes to buy/sell virtual currency and taps the button B51 for selecting buying of the virtual currency or the button B52 for selecting selling of the virtual currency on the screen illustrated in FIG. 6A or taps a part indicating the amount of virtual currency in the text T504 that doubles as a selection button. Then, the instruction processing section 327 transmits an instruction of the selection to the server 110. Based on the instruction of the selection, the transaction management section 315 and the display processing section 318 of the server 110 generate image data for a screen for the user to input a buying/selling amount of virtual currency and transmit the image data to the terminal 120. Based on the image data, the display processing section 328 of the terminal 120 provides display of, for example, a screen for inputting a buying/selling amount of virtual currency, which is illustrated in FIG. 6B, on the input/output I/F 321 (output section).

The display processing section 328 provides display of all of the texts T500 to T505 and the buttons B50 to B52 except the chart C50 from among the items illustrated in FIG. 6A in the part from the upper part to the middle part of the screen illustrated in FIG. 6B. Also, the display processing section 328 provides display of a text T510 that doubles as a button for selecting an entry of an amount of the virtual currency after the decimal point, a button B53 for completing an input of an amount of the virtual currency and a numeric keypad K50 for designating an amount of virtual currency in the part from the middle part to the lower part of the screen illustrated in FIG. 6B. Here, the screen illustrated in FIG. 6B is a screen where the button B51 for selecting buying of the virtual currency has been tapped (that is, a screen for inputting a buying amount) on the screen illustrated in FIG. 6A or FIG. 6B, and a value of the buying/selling amount of the virtual currency. The amount being multiplied by the buying price illustrated in the text T502, is displayed as the Japanese yen equivalent amount in the text T504.

Here, the user taps, for example, “1” of the numeric keypad K50 on the screen for inputting a buying/selling amount of the virtual currency, which is illustrated in FIG. 6B. Then, the instruction processing section 327 causes the amount of “1” to be displayed in the text T504 indicating a buying/selling amount of the virtual currency. Also, the instruction processing section 327 causes a Japanese yen equivalent amount calculated by the transaction management section 325 to be displayed (the state illustrated in FIG. 6B). Note that if, in order to input an amount after the decimal point, the user taps a part of the text T510, the part indicating such amount, for example, “+0.01”, the transaction management section 325 switches an entry of a numeric value from the numeric keypad K50 from a unit amount to an amount in the second decimal place. Further, if the user taps, for example, “5” of the numeric keypad K50, a value of the buying/selling amount with “0.05” added thereto is displayed in the text T504.

### (Step S43)

Next, in step S43, the user taps the button B53 for providing an instruction of completion of an entry of the buying amount of the virtual currency or the user taps the button B51 for selecting buying of the virtual currency again. The instruction processing section 327 transmits an input completion instruction of the buying amount to the server 110. Based on the input completion instruction, the transaction management section 315 and the order processing section 316 of the server 110 generate a buy order from the user and calculate a price of the buy order from the buying amount of the virtual currency and the unit buying price. Also, the transaction management section 315 and the display processing section 318 of the server 110 generate image data of a screen for the user to confirm the buying amount of the virtual currency and the price of the buy order and place the buy order, and transmit the image data to the terminal 120. Based on the image data, the display processing section 328 of the terminal 120 provides display of an order screen for the buy order on the input/output I/F 321 (output section).

As described above, the processing in step S43 corresponds to an example of the “step of generating a buy order of the transaction subject” in the present disclosure and the control section 313 including the transaction management section 315 and the order processing section 316 in the server 110 corresponds to an example of the “order generation section” in the present disclosure.

The display processing section 328 also provides display of a text T520 indicating that the selected menu item is a menu item for buying the virtual currency, the button B50 for returning to a previous menu, a text T521 indicating the buying amount of virtual currency (here, “2” units), a text T522 indicating a current unit buying price and a text T523 indicating a total price of the buy order, in the part from the upper part to the middle part of the screen illustrated in FIG. 6C. The display processing section 328 also provides display of the button B51 for finally selecting placement of the buy order in the lowermost part of the screen illustrated in FIG. 6C.

### (Step S44)

Furthermore, in step S44, the transaction management section 315 and the fund processing section 317 of the server 110 read information on a deposit in the transaction account AC1 and information on a fund in the fund transfer account AC2 as of the point of time of the generation of the buy order, from the storage section 314. Also, the transaction management section 315 and the display processing section 318 of the server 110 generate image data for displaying the deposit in the transaction account AC1 and the fund in the fund transfer account AC2 and transmit the image data to the terminal 120. Based on the image data, the display processing section 328 provides display of a text T524 indicating (a balance of) the deposit in the transaction account AC1 and a text T525 indicating (a balance of) the fund in the fund transfer account AC2 in the middle part of the screen displayed on the input/output I/F 321 (output section), which is illustrated in FIG. 6C. Note that step S44 only needs to be performed after step S40 and is not limited to this example. Step S44 may be performed, for example, but not limited to, between step S40 and step S41. In this case, the user can confirm his/her own account information before performing the operation for the buy order.

### (Steps S45 and S46)

Furthermore, in step S45, the transaction management section 315 and the fund processing section 317 of the server 110 compare the price of the buy order and the deposit in the transaction account AC1 as of the point of time of the generation of the buy order. Then, if the balance of the deposit in the transaction account AC1 is insufficient for the buy order (Yes in step S45), the transaction management section 315 and the fund processing section 317 generate image data of, e.g., a message for urging the user to note that the balance is insufficient and image data for asking the user about whether or not to transfer the fund in the fund transfer account AC2 to the transaction account AC1 and appropriate the fund for the payment of the buy order, and transmit the image data to the terminal 120. Based on the image data, the display processing section 328 provides display of a text T526 indicating that the balance is insufficient and a button B54 for asking whether or not to appropriate the fund in the fund transfer account AC2 for the payment of the buy order, in the lower part of the screen displayed on the input/output I/F 321 (output section), which is illustrated in FIG. 6C. The user taps the button B54 to enable/disable the button B54 and thereby can provide an instruction regarding whether or not to approve a fund transfer from the fund transfer account AC2 to the transaction account AC1. Then, in step S46, the transaction management section 315 and the fund processing section 317 of the server 110 confirms whether or not the fund transfer from the fund transfer account AC2 to the transaction account AC1 has been approved. Here, it should be understood that a comprehensive approval may be obtained in advance from the user to prevent asking for the user's approval for each transaction. In this case, the user's operation can be further simplified, and as a result, a load on the information processing terminal can be reduced.

### (Step S47)

In step S47, if the user's approval of the fund transfer has been obtained in step S46 (Yes in step S46), the transaction management section 315 and the fund processing section 317 of the server 110 transfer an amount of fund that is equal to or exceeds an amount of the balance insufficiency for the buy order, from the fund transfer account AC2 to the transaction account AC1. For example, in the buy order in the screen example illustrated in FIG. 6C, a balance insufficiency of 89,000 yen occurs with the deposit (1000 yen) in the transaction account AC1 for the price of the buy order (90,000 yen). Thus, a fund transfer of an amount of fund that is equal to or exceeds 89,000 yen, which is the balance insufficiency, is performed from the fund transfer account AC2 to the transaction account AC1. As a result of such fund transfer, the insufficiency of the balance of the deposit in the transaction account AC1 for the buy order is eliminated.

As described above, the processing in step S47 corresponds to an example of the “step of transferring a fund” in the present disclosure. Further, the control section 313 including the transaction management section 315 and the fund processing section 317 in the server 110 corresponds to an example of the “fund transfer section” in the present disclosure.

### (Step S48)

Subsequently, in step S48, the user makes a final confirmation of the content of the buy order on the screen illustrated in FIG. 6C and taps the button B51 for making a choice to place the buy order. Then, the instruction processing section 327 transmits an instruction of the order placement choice to the server 110. Based on the instruction of the order placement choice, the transaction management section 315 of the server 110 places the buy order. Further, the transaction management section 315, if there is a sell order of a reverse transaction for the buy order, effects a transaction for matching the buy order and the sell order to establish an agreement of the user's buy order, and ends the transaction relating to the buy order. Also, in step S45, if the balance of the deposit in the transaction account AC1 is not insufficient for the buy order (No in step S45), the transaction management section 315 of the server 110 makes the processing transition from step S45 to step S48 to place the buy order and establish an agreement of the buy order. As described above, the processing in step S48 corresponds to an example of the “step of placing the buy order and establishing an agreement of the buy order” in the present disclosure.

On the other hand, in step S46, if the user's approval of the fund transfer has not been obtained (No in step S46), the transaction management section 315 of the server 110 invalidates the buy order and ends the transaction relating to the buy order.

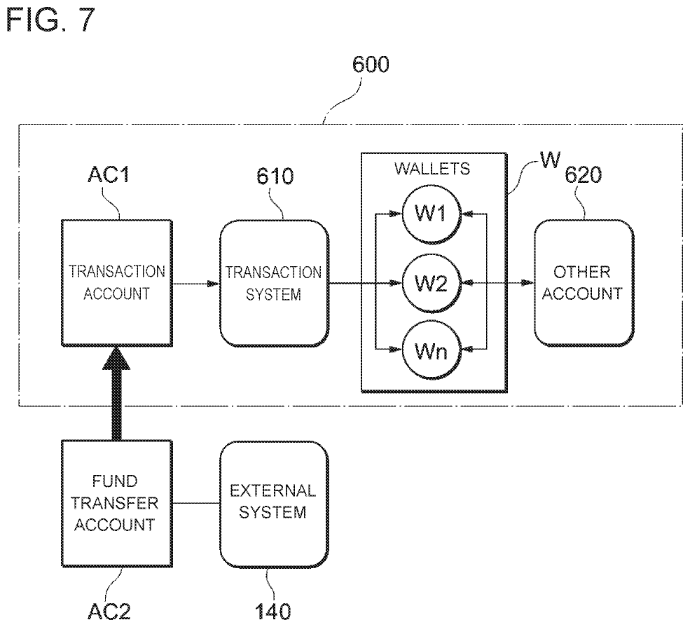

Here, FIG. 7 conceptually illustrates an example of a processing flow in an information processor according to the first embodiment. As illustrated in the figure, the buy order in the above-described virtual currency buy/sell transaction is placed with a virtual currency exchange 600 by an electro transaction system 610 built by the server 110, which is an information processor 200. Upon the agreement of the buy order, the deposit in the transaction account AC1 is provided for the payment. However, as already described with reference to the flowchart of the processing in FIG. 5, prior to the placement of the buy order, if the balance of the deposit in the transaction account AC1 is insufficient, based on the user's approval, a transfer of a fund from the fund transfer account AC2 to the transaction account AC1 (indicated by the bold arrow directed from the fund transfer account AC2 to the transaction account AC1 in FIG. 7) is performed to appropriate the fund for the payment.

Also, the purchased virtual currency is temporarily stored in, for example, a wallet W (wallets W1, W2, . . . , Wn are provided for respective virtual currencies), which is a web wallet (exchange wallet). However, the virtual currency stored in the wallet W can appropriately be, for example, transferred, withdrawn or moved to another account hold by the user (including another wallet), the other account being different from the transaction account AC1, or an account held by a party other than the user. Conversely, virtual currency can appropriately be, for example, transferred, deposited or moved from such other account to the wallet W.

### First Example

A first example of the first embodiment is an example in which proceeds from a particular commercial transaction (e.g., an online auction or one online shopping) are used to buy virtual currency via a fund transfer account AC2, using an electro transaction system 610. A configuration of this first example is equivalent to that of an information processor according to the first embodiment is used. Further, in this first example, a transfer of the fund from the fund transfer account AC2 to a transaction account AC1 can be performed in a procedure that is equivalent to that in the first embodiment.

### Effects of the First Example

According to the first example of the first embodiment, proceeds obtained by a user from a particular commercial transaction are appropriately temporarily appropriated as a fund in a fund transfer account AC2. Then, in placing a buy order of virtual currency, the fund is transferred from the fund transfer account AC2 to a transaction account AC1, enabling the proceeds from the particular commercial transaction to be effectively used to buy the virtual currency with a simple operation. Also, consequently, substantive choices for a fund to be used for buying of virtual currency can be expanded, enabling enhancement in versatility of an electro transaction system and user convenience.

### Operation and Processing in the First Example

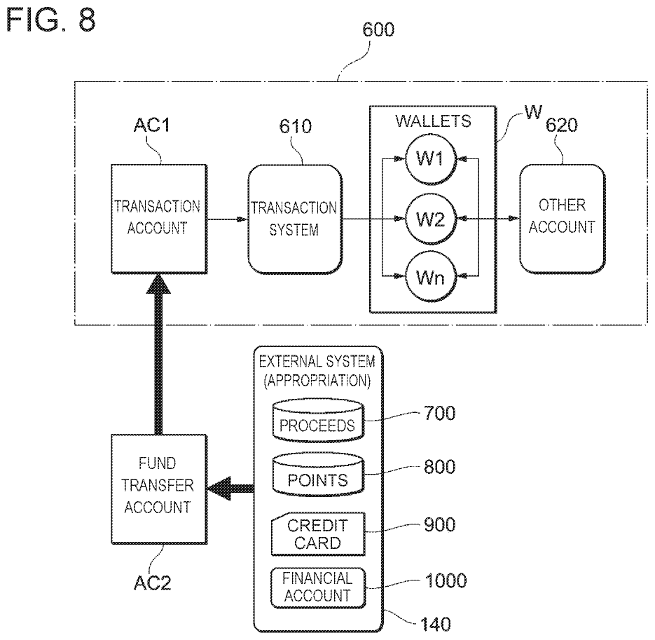

FIG. 8 conceptually illustrates an example of a processing flow in an information processor according to each of first to fourth examples of the first embodiment. As illustrated in the figure, processing in the first example of the first embodiment is performed in a procedure that is equivalent to that of the processing illustrated in FIG. 7, except that proceeds 700 from a particular commercial transaction, the proceeds being held in an external system 140, are appropriated as a fund in the fund transfer account AC2 (indicated by the bold arrow directed from the external system 140 to the fund transfer account AC2 in FIG. 8) in response to an instruction from a user. Here, a timing for appropriating a fund from the external system 140 to the fund transfer account AC2 is not specifically limited. For example, prior to a virtual currency buy/sell transaction and/or at the time of a virtual currency buy/sell transaction, the fund appropriation can be performed.

### Second Example

A second example of the first embodiment is an example in which a money equivalent (e.g., points, a coupon or electronic money) that is usable for a particular service is converted into cash to buy virtual currency via a fund transfer account AC2, using an electro transaction system 610. A configuration of this second example is equivalent to that of an information processor according to the first embodiment is used. Further, in this second example, a transfer of the fund from the fund transfer account AC2 to a transaction account AC1 can be performed in a procedure that is equivalent to that in the first embodiment.

### Effects of the Second Example

According to the second example of the first embodiment, a money equivalent that is usable for a particular service is appropriately temporarily appropriated as a fund in a fund transfer account AC2. Then, in placing a buy order of virtual currency, the fund is transferred from the fund transfer account AC2 to a transaction account AC1, enabling the money equivalent that is usable for the particular service to be effectively used to buy the virtual currency with a simple operation. Also, consequently, substantive choices for a fund to be used for buying of virtual currency can be expanded, enabling enhancement in versatility of an electro transaction system and user convenience.

### Operation and Processing in the Second Example

As illustrated in FIG. 8, processing in the second example of the first embodiment is performed in a procedure that is equivalent to that of the processing illustrated in FIG. 7, except that points 800 (money equivalent) that are usable for a particular service, the points being held in an external system 140, are appropriated as a fund in a fund transfer account AC2 (indicated by the bold line directed from the external system 140 to the fund transfer account AC2 in FIG. 8) in response to an instruction from a user. Here, a timing for appropriating a fund from the external system 140 to the fund transfer account AC2 is not specifically limited. For example, prior to a virtual currency buy/sell transaction and/or at the time of a virtual currency buy/sell transaction, the fund appropriation can be performed.

### Third Example

A third example of the first embodiment is an example in which advance money obtained using a credit card is used to buy virtual currency via a fund transfer account AC2, using an electro transaction system 610. A configuration of this third example is equivalent to that of the information processor according to the first embodiment is used. Further, in this third example, a transfer of the fund from the fund transfer account AC2 to a transaction account AC1 can be performed in a procedure that is equivalent to that in the first embodiment.

### Effects of the Third Example

According to the third example of the first embodiment, advance money obtained using a credit card is appropriately temporarily appropriated as a fund in a fund transfer account AC2. Then, in placing a buy order of virtual currency, the fund is transferred from the fund transfer account AC2 to a transaction account AC1, enabling the advance money obtained using a credit card to be effectively used to buy the virtual currency with a simple operation. Also, consequently, substantive choices for a fund to be used for buying of virtual currency can be expanded, enabling enhancement in versatility of an electro transaction system and user convenience.

### Operation and Processing in the Third Example

As illustrated in FIG. 8, processing in the third example of the first embodiment is performed in a procedure that is equivalent to that of the processing illustrated in FIG. 7, except that advance money obtained by, for example, cash advance using information on a credit card 900, the information being held in an external system 140, is appropriated as a fund in a fund transfer account AC2 (indicated by the bold arrow directed from the external system 140 to the fund transfer account AC2 in FIG. 8) in response to an instruction from a user. Here, a timing for appropriating a fund from the external system 140 to the fund transfer account AC2 is not specifically limited. For example, prior to a virtual currency buy/sell transaction and/or at the time of a virtual currency buy/sell transaction, the fund appropriation can be performed.

### Fourth Example

A fourth example of the first embodiment is an example in which a deposit in a financial account is used to buy virtual currency via a fund transfer account AC2, using an electro transaction system 610. A configuration of this forth example is equivalent to that of the information processor according to the first embodiment is used. Further, in this fourth example, a transfer of the fund from the fund transfer account AC2 to a transaction account AC1 can be performed in a procedure that is equivalent to that in the first embodiment.

### Effects of the Fourth Example

According to the fourth example of the first embodiment, a deposit in a financial account is appropriately temporarily appropriated as a fund in a fund transfer account AC2. Then, in placing a buy order of a virtual currency, the fund is transferred from the fund transfer account AC2 to a transaction account AC1, enabling the deposit in the financial account to be effectively used to buy the virtual currency with a simple operation. Also, consequently, substantive choices for a fund to be used for buying of virtual currency can be expanded, enabling enhancement in versatility of an electro transaction system and user convenience.

### Operation and Processing in the Fourth Example

As illustrated in FIG. 8, processing in the fourth example of the first embodiment is performed in a procedure that is equivalent to that of the procedure illustrated in FIG. 6, except that a deposit in a financial account 1000, the point being held in an external system 140, is appropriated as a fund in a fund transfer account AC2 (indicated by the bold line directed from the external system 140 to the fund transfer account AC2 in FIG. 8) in response to an instruction from a user. Here, a timing for appropriating a fund from the external system 140 to the fund transfer account AC2 is not specifically limited. For example, prior to a virtual currency buy/sell transaction and/or at the time of a virtual currency buy/sell transaction, the fund appropriation can be performed.

### Fifth Example

A fifth example of the first embodiment is an example in which a fund in a fund transfer account AC2 is used for a settlement in a particular commercial transaction or a particular service or transferred to the outside. A configuration of this fifth example is equivalent to that of the information processor according to the first embodiment is used. Further, in this fifth example, a transfer of the fund from the fund transfer account AC2 to a transaction account AC1 can be performed in a procedure that is equivalent to that in the first embodiment.

### Effects of the Fifth Example

According to the fifth example of the first embodiment, money or a money equivalent is appropriated as a fund in a fund transfer account AC2 through any of various channels or is obtained as a profit of a virtual currency buy/sell transaction. Then, the money or money equivalent can be used not only for a virtual currency buying transaction but also for usage such as a settlement in a particular commercial transaction or a particular service or a transfer to the outside. Also, consequently, usage of a fund held in a fund transfer account AC2 can be expanded, enabling enhancement in versatility of an electro transaction system and user convenience.

### Operation and Processing in the Fifth Example

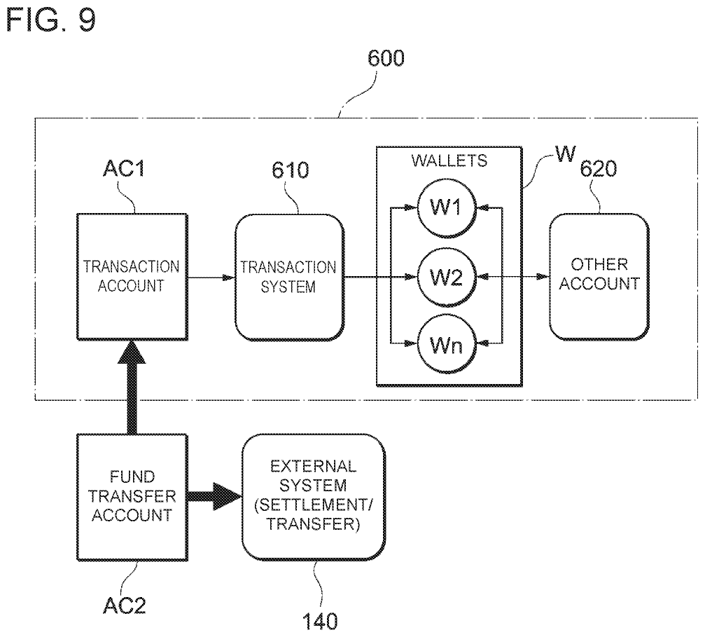

FIG. 9 conceptually illustrates an example of a processing flow in an information processor according to the fifth example of the first embodiment. As illustrated in the figure, processing in the fifth example of the first embodiment is performed in a procedure that is equivalent to that of the processing illustrated in FIG. 7, except that a fund held in a fund transfer account AC2 is used for a settlement in a particular commercial transaction or a particular service provided by an external system 140 or transferred to the external system 140 (indicated by the bold line directed from the fund transfer account AC2 to the external system 140 in FIG. 9) in response to an instruction from a user. Here, a timing of the fund transfer from the fund transfer account AC2 to the external system 140 is not specifically limited. For example, the fund transfer can be performed irrespective of a virtual currency buy/sell transaction.

### Sixth Example

A sixth example of the first embodiment is an example in which a fund in a fund transfer account AC2 is used to purchase a money equivalent (e.g., points, a coupon, electronic money) that is usable for a particular service. A configuration of this sixth example is equivalent to that of the information processor according to the first embodiment is used. Further, in this sixth example, a transfer of the fund from the fund transfer account AC2 to a transaction account AC1 can be performed in a procedure that is equivalent to that in the first embodiment.

### Effects of the Sixth Example

According to the sixth example of the first embodiment, money or a money equivalent is appropriated as a fund in a fund transfer account AC2 through any of various channels or obtained as a profit of a virtual currency buy/sell transaction. Then, the money or money equivalent can be used not only for a virtual currency buying transaction but also for usage such as purchase of a money equivalent that is usable for a particular service. Also, consequently, usage of a fund held in a fund transfer account AC2 can be expanded, enabling enhancement in versatility of an electro transaction system and user convenience.

### Operation and Processing in the Sixth Example

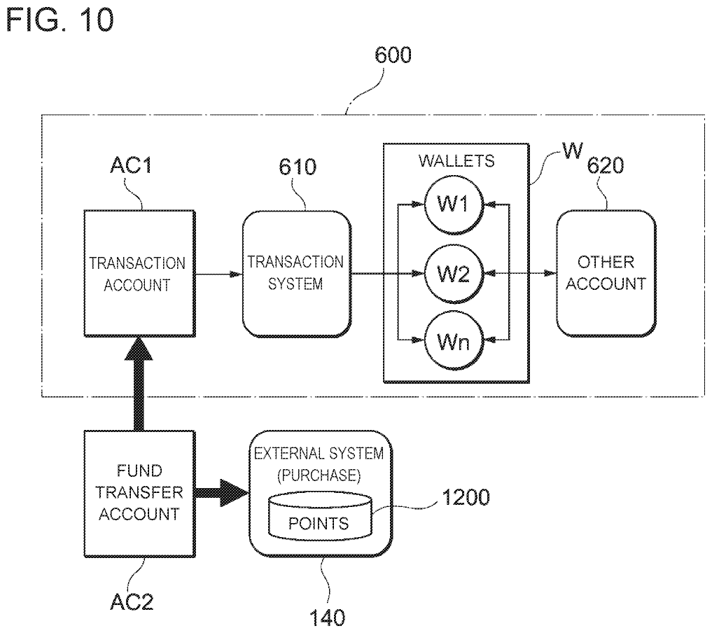

FIG. 10 conceptually illustrates an example of a processing flow in an information processor according to the sixth example of the first embodiment. As illustrated in the figure, processing in the sixth example of the first embodiment is performed in a procedure that is equivalent to that of the processing illustrated in FIG. 6, except that a fund held in a fund transfer account AC2 is used for purchase of points 1200 (money equivalent) that are usable for a particular service provided by an external system 140 (indicated by the bold line directed from the fund transfer account AC2 to the external system 140 in FIG. 10) in response to an instruction from a user. Here, a timing for appropriating a fund from the fund transfer account AC2 to the external system 140 is not specifically limited. For example, the fund appropriation can be performed irrespective of a virtual currency buy/sell transaction.

### Seventh Example

A seventh example of the first embodiment is an example in which a fund in a fund transfer account AC2 is transferred to a financial account in a financial institution as a deposit. A configuration of this seventh example is equivalent to that of the information processor according to the first embodiment is used. Further, in this seventh example, a transfer of the fund from the fund transfer account AC2 to a transaction account AC1 can be performed in a procedure that is equivalent to that in the first embodiment.

### Effects of the Seventh Example

According to the seventh example of the first embodiment, money or a money equivalent is appropriated as a fund in a fund transfer account AC2 through any of various channels or is obtained as a profit of a virtual currency buy/sell transaction. Then the money or money equivalent can be used not only for a virtual currency buying transaction but also for usage such as a transfer to a financial account and appropriation as a deposit. Also, consequently, usage of a fund held in a fund transfer account AC2 can be expanded, enabling enhancement in versatility of an electro transaction system and user convenience.

### Operation and Processing in the Seventh Example

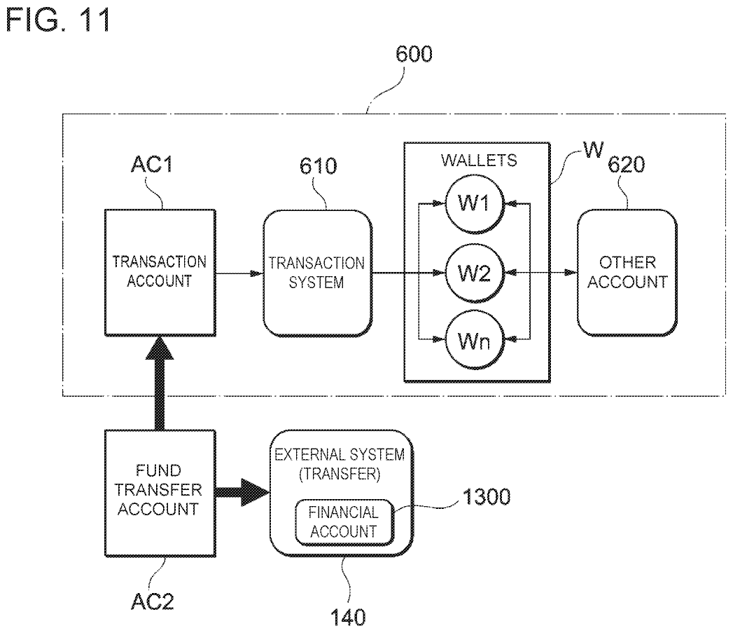

FIG. 11 conceptually illustrates an example of a processing flow in an information processor according to the seventh example of the first embodiment. As illustrated in the figure, processing in the seventh example of the first embodiment is performed in a procedure that is equivalent to that of the processing illustrated in FIG. 7, except that a fund held in a fund transfer account AC2 is transferred as a deposit in a financial account 1300 in an external system 140 such as a financial institution (indicated by the bold line directed from the fund transfer account AC2 to the external system 140 in FIG. 11) in response to an instruction from a user. Here, a timing for appropriating a fund from the fund transfer account AC2 to the external system 140 is not specifically limited. For example, the fund appropriation can be performed irrespective of a virtual currency buy/sell transaction.

### Eighth Example

An eighth example of the first embodiment is an example in which a user's approval of transfer of a fund from a fund transfer account AC2 to a transaction account AC1 is obtained in advance prior to buy orders. Then, if a deposit balance is insufficient for a buy order, a fund transfer is automatically performed without obtainment of the user's approval for each buy order, in order to appropriate the fund for payment of the buy order.

### Effects of the Eighth Example

According to the eighth example of the first embodiment, a user's approval of fund transfer is obtained in advance. Thus, even if a deposit balance is insufficient for a buy order, a fund in a fund transfer account AC2 can quickly be transferred to a transaction account AC1 to appropriate the fund for payment without obtainment of the user's approval of fund transfer for each buy order. Consequently, a buy order can further smoothly be placed and processing time can further be reduced, enabling further reduction of a user's stress and a desired transaction to be performed at a more proper timing.

### Operation and Processing in the Eighth Example

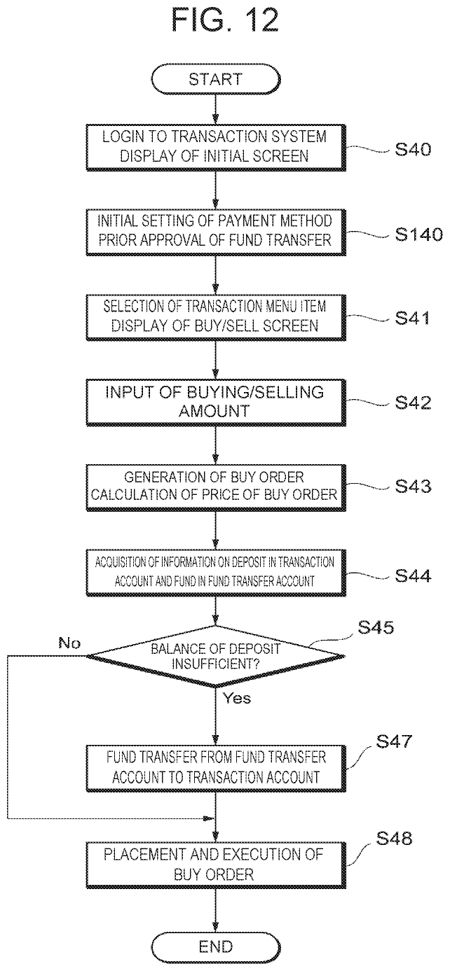

FIG. 12 illustrates an example of a flowchart of processing in the information processor according to the eighth example of the first embodiment. FIG. 12 also indicates a flow illustrating an example of a processing procedure in an information processing method according to the present disclosure. As illustrated in the figure, in the eighth example of the first embodiment, processing is performed in a procedure that is equivalent to that of the first embodiment illustrated in FIG. 5, except that: step S140 is performed between step S40 in which a user logins to an electro transaction system and an initial screen is displayed and step S41 in which a transaction menu item is selected; and step S46 is not included.

In step S140, first, a user selects a menu item for initial setting of a payment method from among various setting menu items. Then, a transaction management section 315 and a display processing section 318 of a server 110 generate image data for displaying choices for a type of fund to be used for payment of a buy order (payment method) and transmits the image data to a terminal 120. Based on the image data, a display processing section 328 of the terminal 120 provides display of an initial setting screen for a payment method on an input/output I/F 321 (output section).

Examples of the choices for the payment method include, e.g., a deposit in the transaction account AC1, a fund in the fund transfer account AC2, proceeds 700 from a particular commercial transaction, which has been described in the above examples, points 800 (money equivalent) that are usable for a particular service, advance money that can be obtained using information on a credit card 900 and a deposit in a financial account 1000. If the user wishes to give a prior approval of fund transfer from the fund transfer account AC2, the user can give such prior approval by selecting a choice other than the deposit in the transaction account AC1 from among the choices and registering such setting.

Where such initial setting for the payment method is registered, if a deposit balance in the transaction account AC1 is insufficient in step S45 illustrated in FIG. 12, the transaction management section 315 and the fund processing section 317 of the server 110 perform a fund transfer from the fund transfer account AC2 to the transaction account AC1 without obtainment of the user's approval of fund transfer for each time. Note that if any of the proceeds 700 from a commercial transaction, the points 800 (money equivalent), the advance money obtained using the credit card 900 and the deposit in the financial account 1000 is selected as the payment method, the transaction management section 315 and the fund processing section 317 of the server 110 preferentially perform processing for appropriating the selected payment method for a fund in the fund transfer account AC2 and furthermore, automatically perform a fund transfer from the fund transfer account AC2.

Note that the present example substantively includes a mode in which even if there is no balance of the transaction account AC1, when a buy order is generated (for example, when the “BUY” button is tapped in FIG. 6B), a fund transfer is performed and a buy order is placed. Therefore, the present example corresponds also to an example in which in response to a user's operation relating to a buy order, an amount of fund that is equal to or exceeds an amount of insufficiency of balance is transferred from the fund transfer account AC2 to the transaction account AC1.

### Ninth Example

The above example has been described in terms of a case where at least any of the proceeds 700, the points 800 (money equivalent), the advance money obtained using the credit card 900 and the deposit in the financial account 1000 is selected as a payment method.

The ninth example of the first embodiment is an example in which any combination of proceeds 700, points 800 (money equivalent), advance money using the credit card 900 and a deposit in a financial account 1000, which are choices for a payment method, is selected according to a predetermined condition.

### Effects of the Ninth Example

According to the ninth example of the first embodiment, a plurality of payment methods according to a user's selection can be selected, enabling provision of a more flexible payment method. Also, according to the ninth example of the first embodiment, even if each of proceeds 700, points 800 (money equivalent), advance money obtained using a credit card 900 and a deposit in a financial account 1000 is small, a transaction can be made with a total amount thereof.

### Operation and Processing in the Ninth Example

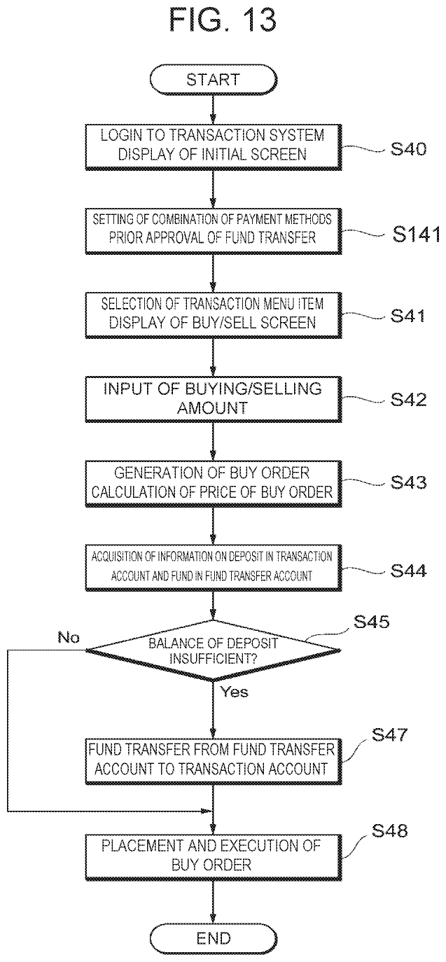

FIG. 13 illustrates an example of a flowchart of processing in the information processor according to the ninth example of the first embodiment. FIG. 13 also indicates a flow illustrating an example of a processing procedure in an information processing method according to the present disclosure. As illustrated in the figure, in the ninth example of the first embodiment, processing in a procedure that is equivalent to that of the first embodiment illustrated in FIG. 5 is performed, except that: step S141 is performed between step S40 in which a user logins to an electro transaction system and an initial screen is displayed and step S41 in which a transaction menu is selected; and step S46 is not included.

In step S141, a combination of a plurality of payment methods from among proceeds 700, points 800 (money equivalent), advance money obtained using a credit card 900 and a deposit in a financial account 1000 is set according to a predetermined condition. Here, examples of the predetermined condition include a condition that a setting made by the user is received in advance and a condition that the combination is made based on an appropriate order of priority.

Where a setting made by the user is received in advance, the user can select a menu item for initial setting of a payment method from among various setting menu items. Then, a transaction management section 315 and a display processing section 318 of a server 110 generate image data for displaying choices for a type of fund to be used for payment of a buy order (payment method) and transmits the image data to a terminal 120. Based on the image data, a display processing section 328 of the terminal 120 provides display of an initial setting screen for a payment method on an input/output I/F 321 (output section). The user can select a plurality of payment method items, from among the proceeds 700, the points 800 (money equivalent), the advance money obtained using the credit card 900 and the deposit in the financial account 1000, on the initial setting screen and register such setting.

Also, where the combination is made based on an appropriate order of priority, the transaction management section 315 of the server 110 may set a combination of a plurality of payment methods by, from among the proceeds 700, the points 800 (money equivalent), the advance money obtained using the credit card 900 and the deposit in the financial account 1000. For example, those having a smaller balance can be combined (the balances of the payment sources can be made to zero) or conversely those having a larger balance can be combined, or those used for more recent payment can be combined, or the user may select and set the priority order itself.

Where such payment method combination is set, if a deposit balance in a transaction account AC1 is insufficient in step S45 illustrated in FIG. 13, the transaction management section 315 and the fund processing section 317 of the server 110 preferentially perform processing for appropriating a fund to the fund transfer account AC2 without obtainment of the user's approval of fund transfer for each time. Furthermore, in such case, the transaction management section 315 and the fund processing section 317 automatically perform a fund transfer from the fund transfer account AC2 to the transaction account AC1.

### Tenth Example

A tenth example of the first embodiment is an example in which a price of a fund transferred between a transaction account AC1 and a fund transfer account AC2 is determined according to a rate for a transaction made using the transaction account AC1. Where the transaction is a virtual currency transaction, it is known that the price largely varies even during a short period of time. Therefore, the price varies depending on the timing of determination of the rate, and thus, the transaction may be made at a price not intended by a user.

### Effects of the Tenth Example

According to the tenth example of the first embodiment, a rate can be determined at a proper timing, preventing a fund to be transferred between a transaction account AC1 and a fund transfer account AC2 at a price not intended by a user.

### Operation and Processing in the Tenth Example

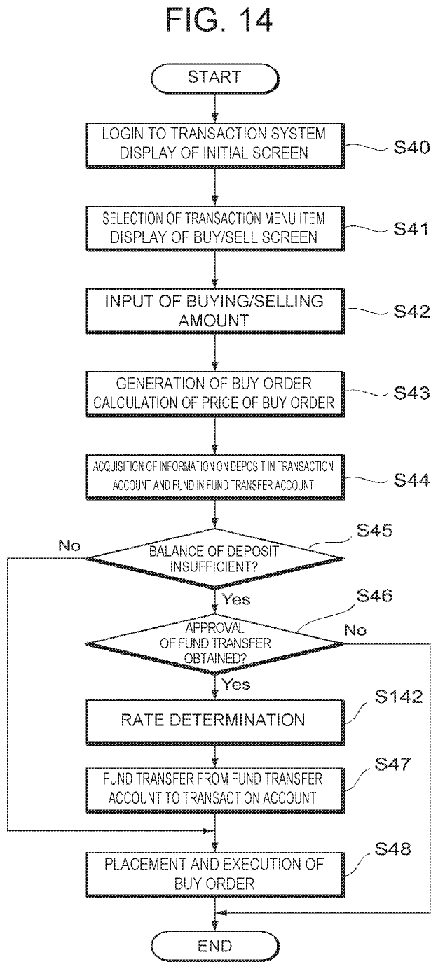

FIG. 14 illustrates an example of a flowchart of processing in the information processor according to the tenth example of the first embodiment. FIG. 14 also indicates a flow illustrating an example of a processing procedure in an information processing method according to the present disclosure. As illustrated in the figure, in the tenth example of the first embodiment, processing is performed in a procedure that is equivalent to that of the first embodiment illustrated in FIG. 5, except that: in step S142, a price of fund to be transferred between a transaction account AC1 and a fund transfer account AC2 is determined according to a rate for a transaction made using the transaction account AC1.

For example, where an approval of fund transfer from a user is obtained for each transaction as in the first embodiment illustrated in FIG. 5, a method in which a rate is determined at the time of obtainment of the approval and a method in which a rate that is an average value or a center value of rates during a predetermined period of time from the obtainment of the approval (a fixed period of time set in advance or a period of time until the fund transfer is actually performed) is determined are conceivable.

Also, as in the eighth example of the first embodiment illustrated in FIG. 12 and the ninth example of the first embodiment illustrated in FIG. 13, where an approval of fund transfer from a user is obtained in advance (a comprehensive approval is obtained), a method in which a rate as of the time when a fund transfer was actually performed is determined as the rate. Further, examples of such method include a method in which based on information on a time, the information being acquired by a terminal 120 and transmitted to a server 110, the server 110 employs a rate as of that time and a method in which a server 110 employs a rate as of the time when the server 110 received an instruction for the fund transfer.

### Second Embodiment

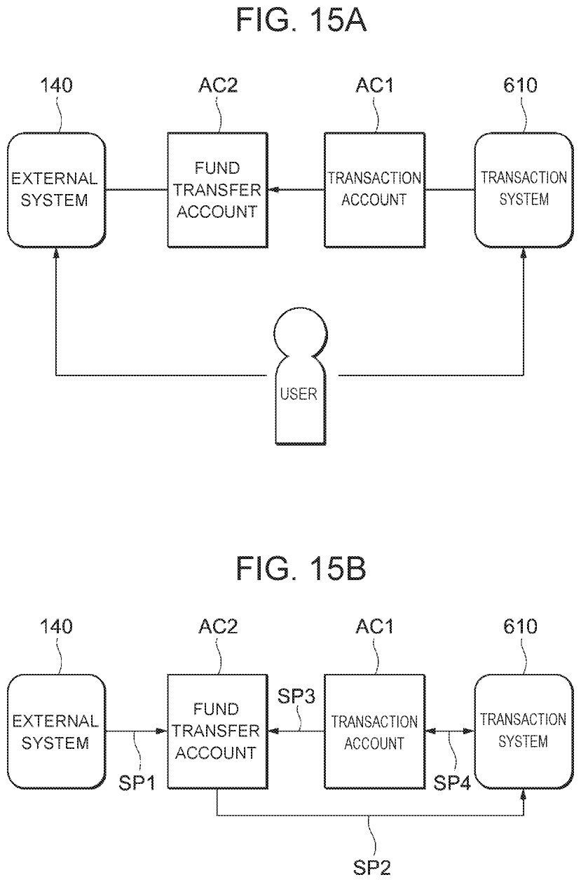

A second embodiment is an embodiment indicating an example of application of the present disclosure to a service that allows a user to make a buy/sell transaction of a transaction subject online via a network 130, using a terminal 120. FIGS. 15A and 15B are diagrams schematically illustrating an overview of the second embodiment. As illustrated in FIG. 15A, in the second embodiment, for example, an electro transaction system 610 for performing a buy/sell transaction of a transaction subject is built by a server 110. A user transmits a desired buy/sell order to the electro transaction system 610 from a terminal 120 through a network 130. The electro transaction system 610 places the buy/sell order with a predetermined exchange and establishes an agreement of buying and selling of the transaction subject. Also, in order to use the service provided by the electro transaction system 610, a transaction account AC1 is opened for each user. The user can appropriate holding agreed payment of a sell order of the transaction subject as a deposit in the transaction account AC1. Furthermore, the deposit in the transaction account AC1 can appropriately be transferred to a fund transfer account AC2 that is different from the transaction account AC1, based on the user's approval on the electro transaction system 610.

Also, the fund transfer account AC2 is an account that is different from the transaction account AC1, which is a withdrawal source account for the electro transaction system 610. Furthermore, the fund transfer account AC2, for example, can be used as a withdrawal source account where an external system 140 such as a financial institution or an electronic commerce service is used. Then, each of the second embodiment and later-described examples of the second embodiment may be practiced where when a user makes a transaction using a fund transfer account AC2 as a withdrawal source account, a balance of the fund transfer account AC2 is insufficient.

For example, as illustrated in FIG. 15B, where an electronic transaction is performed in an external system 140, if a user purchases a product or a service, for settlement processing for the purchase, the external system 140 compares a balance of the fund transfer account AC2, which is a withdrawal source account, and a purchase price of the product with each other (step SP1). As a result, if the purchase price of the product exceeds the balance of the fund transfer account AC2, a request for appropriate a deposit for the insufficiency is transmitted to the electro transaction system 610 or the transaction account AC1 (step SP2). If the transaction account AC1 has an amount of deposit that is equal to or exceeds the insufficiency requested, the electro transaction system 610 may appropriate the deposit to the fund transfer account AC2 (step SP3). Alternatively, if the transaction account AC1 has no amount of deposit that is equal to or exceeds the insufficiency requested or regardless of the balance of the deposit in the transaction account AC1, the relevant amount of virtual currency is sold at a rate as of that point of time, the payment is temporarily deposited in the transaction account AC1 (step SP4) and then is appropriated to the fund transfer account AC2 (step SP3).

As described above, employment of the disclosure of the second embodiment enables a user to make a commercial transaction without performing a special operation. Note that the service provided by the external system 140 is not limited to electronic transactions, and may be any service as long as such service is a predetermined service using the fund transfer account AC2 as a withdrawal source account. Also, examples of the predetermined service include, but not limited to, electronic transactions, content selling services, subscription-type services and financial services.

### Effects of the Second Embodiment

According to the second embodiment, the trouble of a deposit/withdrawal operation needed in a conventional transaction system that performs a buy/sell transaction can be reduced. As a result, botheration a user conventionally has in a deposit/withdrawal operation (in particular, a withdrawal operation) may be removed, and thus enabling enhancement in convenience of a transaction service and quality of the service for a user. In other words, the second embodiment eliminates the need for a conventional procedure or operation necessary for transfer of money from a transaction account to a financial account or a withdrawal source account for use of another external service, enabling a buy/sell transaction of a transaction subject or use of an external system to be performed “smoothly” by a seamless operation in an electro transaction system or the external system. As a result, the number of operations by a user is decreased and stress is thus reduced, enabling enhancement in user convenience. Also, the user's willingness for a buy/sell transaction or use of the external system can be maintained. Furthermore, the user can make a buy/sell transaction at a desired timing without missing a chance for the transaction.

### (1) Configuration of the Server

A configuration of the server 110 in the second embodiment is equivalent to the configuration of the server 110 in the first embodiment, and thus, detailed description thereof will be omitted here.

### (2) Configuration of the Terminal

A configuration of the terminal 120 in the second embodiment is equivalent to the configuration of the terminal 120 in the first embodiment, and thus, detailed description thereof will be omitted here.

### Operation and Processing in the Second Embodiment

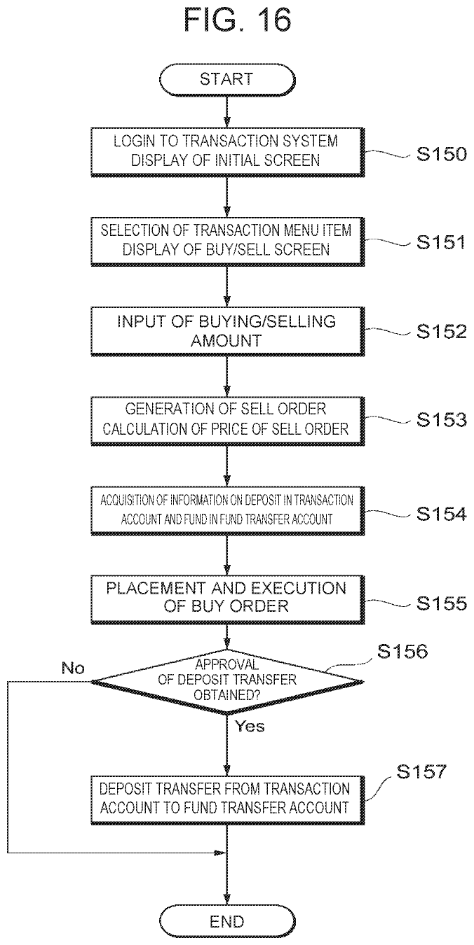

Processing in information processors according to the second embodiment will be described with reference to FIGS. 16 to 18. FIG. 16 illustrates an example of a flowchart of processing in information processors according to the second embodiment. FIG. 16 also indicates a flow illustrating an example of a processing procedure in an information processing method according to the present disclosure. Note that the below-described processing procedure is a mere example and each of the steps of processing may be changed as long as such change is possible within the scope of the technical idea of the present disclosure and appropriate omission, replacement and addition of steps are possible.

### (Step S150)

First, upon the user starting up the terminal 120 and executing an electro transaction system application (program), a login screen for login to the electro transaction system is displayed on an input/output I/F 321 of the terminal 120. In step S150, upon the user inputting his/her own login information from the input/output I/F 321 (input section), an instruction processing section 327 transmits the information to the server 110. If the login information is correct, a transaction management section 315 of the server 110 permits the user's login and transmits image data of an initial screen generated by a display processing section 318 to the terminal 120. A display processing section 328 of the terminal 120 provides display of the initial screen on the input/output I/F 321 (output section) based on the image data.

The initial screen is not specifically limited and examples of the initial screen can include, e.g., a particular screen provided as a default, a screen for various settings, a screen for information on a transaction account AC1, a screen for information on a fund transfer account AC2, a screen for information on a wallet W, a menu selection screen, a screen for information relating to virtual currency (e.g., transaction prices, a chart and a board), a virtual currency list (selection) screen, a screen for a specific virtual currency transaction, a screen displayed at the time of the user's last login, a screen customized by the user and a screen that is any combination of these screens. Note that as described above, the transaction account AC1 and a deposit in the transaction account AC1 and the fund transfer account AC2 and the fund in the fund transfer account AC2 are associated with relevant user information X. The transaction management section 315 and a fund processing section 317 of the server 110 manages buy/sell orders of virtual currency placed by the user and the deposit in the transaction account AC1 and the fund in the fund transfer account AC2. As described above, the transaction management section 315 and the fund processing section 317 correspond to respective examples of the “account management section” and the “deposit management section” in the present disclosure.

### (Step S151)

Next, in step S151, upon the user selecting a desired virtual currency transaction menu item on the initial screen (for example, the menu selection screen), the instruction processing section 327 transmits an instruction of the selection to the server 110. Based on the instruction of the selection, the transaction management section 315 and the display processing section 318 of the server 110 generate image data of a screen for buying/selling the virtual currency designated by the user and transmits the image data to the terminal 120. Based on the image data, the display processing section 328 of the terminal 120 provides display of a buy/sell screen for the virtual currency on the input/output I/F 321 (output section).

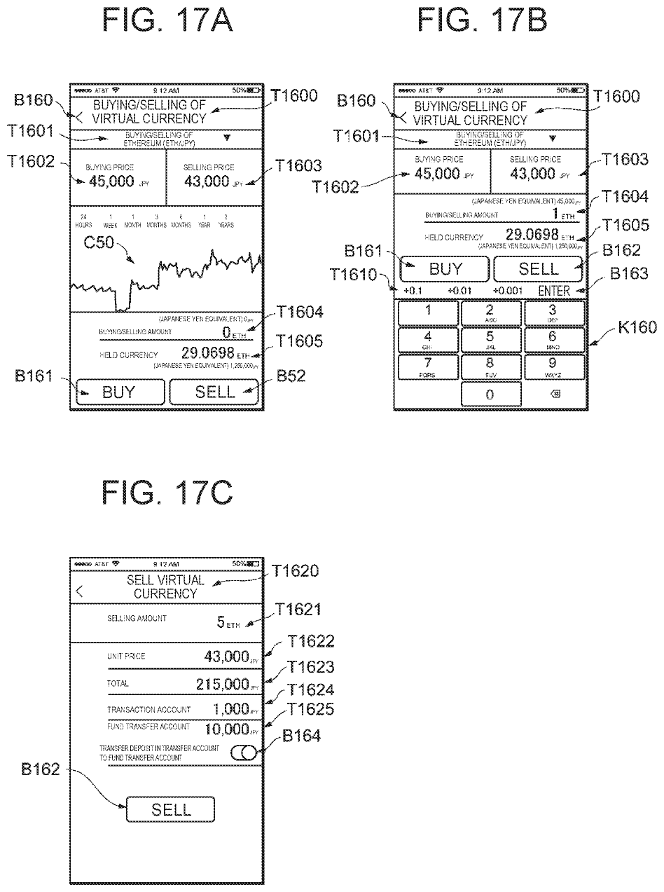

Here, FIGS. 17A to 17C illustrate an example of transition of screens displayed on a terminal 120 in processing in information processors according to the second embodiment. In step S151, in response to an instruction of the selection of the transaction menu item from the user, first, for example, the screen illustrated in FIG. 17A is displayed on the terminal 120. The display processing section 328 provides display of a text T1600 indicating that the selected menu item is a menu item for buying/selling of virtual currency, a button B160 for returning to a previous menu, a text T1601 indicating a kind of the selected virtual currency, a text T1602 indicating a current unit buying price, a text T1603 indicating a current unit selling price, a chart C160 indicating chronological transition of a price of the selected virtual currency (the period of the chart can be changed), a text T1604 indicating a buying/selling amount of the virtual currency and a Japanese yen equivalent amount for the amount, a text T1605 indicating an amount of the selected virtual currency held by the user and a Japanese yen equivalent amount for the amount, a button B161 for selecting buying of the virtual currency and a button B162 for selecting selling of the virtual currency, in the order from the upper part to the lower part of the screen illustrated in FIG. 17A.

### (Step S152)

Next, in step S152, the user wishes to buy/sell virtual currency and taps the button B161 for selecting buying of the virtual currency or the button B162 for selecting selling of the virtual currency on the screen illustrated in FIG. 17A or taps a part indicating the amount of virtual currency in the text T1604 that doubles as a selection button. Then, the instruction processing section 327 transmits an instruction of the selection to the server 110. Based on the instruction of the selection, the transaction management section 315 and the display processing section 318 of the server 110 generate image data for a screen for the user to input a buying/selling amount of virtual currency and transmit the image data to the terminal 120. Based on the image data, the display processing section 328 of the terminal 120 provides display of, for example, a screen for inputting a buying/selling amount of virtual currency, which is illustrated in FIG. 17B, on the input/output I/F 321 (output section).

The display processing section 328 provides display of all of the texts T1600 to T1605 and the buttons B160 to B162 except the chart C160 from among the items illustrated in FIG. 17A in the part from the upper part to the middle part of the screen illustrated in FIG. 17B. Also, the display processing section 328 provides display of a text T1610 that doubles as a button for selecting an entry of an amount of the virtual currency after the decimal point, a button B163 for completing an input of an amount of the virtual currency and a numeric keypad K160 for designating an amount of virtual currency in the part from the middle part to the lower part of the screen illustrated in FIG. 17B. Here, the screen illustrated in FIG. 17B is a screen where the button B162 for selecting selling of the virtual currency has been tapped (that is, a screen for inputting a selling amount) on the screen illustrated in FIG. 17A or FIG. 17B, and a value of the buying/selling amount of the virtual currency. The amount being multiplied by the selling price illustrated in the text T1603, is displayed as the Japanese yen equivalent amount in the text T1604.

Here, the user taps, for example, “1” of the numeric keypad K160 on the screen for inputting a buying/selling amount of the virtual currency, which is illustrated in FIG. 17B. Then, the instruction processing section 327 causes the amount of “1” to be displayed in the text T1604 indicating a buying/selling amount of the virtual currency. Also, the instruction processing section 327 causes a Japanese yen equivalent amount calculated by a transaction management section 325 to be displayed (the state illustrated in FIG. 17B). Note that if, in order to input an amount after the decimal point, the user taps a part of the text T1610, the part indicating such amount, for example, “+0.01”, the transaction management section 325 switches an entry of a numeric value from the numeric keypad K160 from a unit amount to an amount in the second decimal place. Further, if the user taps, for example, “5” of the numeric keypad K160, a value of the buying/selling amount with “0.05” added thereto is displayed in the text T1604.

### (Step S153)

Next, in step S153, the user taps the button B163 for providing an instruction of completion of an entry of the selling amount of the virtual currency or the user taps the button B162 for selecting selling of the virtual currency again. The instruction processing section 327 transmits the input completion instruction of the selling amount to the server 110. Based on the input completion instruction, the transaction management section 315 and an order processing section 316 of the server 110 generate a sell order from the user and calculates a price of the sell order from the selling amount of the virtual currency and the unit selling price. Also, the transaction management section 315 and the display processing section 318 of the server 110 generate image data of a screen for the user to confirm the selling amount of the virtual currency and the price of the sell order and place the sell order, and transmits the image data to the terminal 120. Based on the image data, the display processing section 328 of the terminal 120 provides display of an order screen for the sell order on the input/output I/F 321 (output section). As described above, the processing in step S153 corresponds to an example of the “step of generating a sell order of the transaction subject” in the present disclosure.

The display processing section 328 also provides display of a text T1620 indicating that the selected menu item is a menu item for selling the virtual currency, the button B160 for returning to a previous menu, a text T1621 indicating the selling amount of virtual currency (here, “5” units), a text T1622 indicating a current unit selling price and a text T1623 indicating an agreed total price of the sell order, in the part from the upper part to the middle part of the screen illustrated in FIG. 17C. The display processing section 328 also provides display of the button B162 for finally selecting placement of the sell order in the lowermost part of the screen illustrated in FIG. 17C.

### (Step S154)

Furthermore, in step S154, the transaction management section 315 and the fund processing section 317 of the server 110 read information on a deposit in the transaction account AC1 and information on a fund in the fund transfer account AC2 as of the point of time of the generation of the sell order, from the storage section 314. Also, the transaction management section 315 and the display processing section 318 of the server 110 generate image data for displaying the deposit in the transaction account AC1 and the fund in the fund transfer account AC2 and transmit the image data to the terminal 120. Based on the image data, the display processing section 328 provides display of a text T1624 indicating (a balance of) the deposit in the transaction account AC1 and a text T1625 indicating (a balance of) the fund in the fund transfer account AC2 in the middle part of the screen displayed on the input/output I/F 321 (output section), which is illustrated in FIG. 17C. Note that step S154 only needs to be performed after step S150 and is not limited to this example. Step S154 may be performed, for example, but not limited to, between step S150 and step S151. In this case, the user can confirm his/her own account information before performing the operation for the sell order.

Also, in step S154, the transaction management section 315 and the fund processing section 317 of the server 110 generate image data for asking the user about whether or not to, if the sell order has been placed and an agreement of the sell order has been established, transfer the deposit including the agreed payment in the transaction account AC1 to the fund transfer account AC2 and transmit the image data to the terminal 120. Based on the image data, the display processing section 328 provides display of a button B164 for selecting whether or not to transfer the deposit including the agreed payment of the sell order in the transaction account AC1 to the fund transfer account AC2 on the lower part of the screen displayed on the input/output I/F 321 (output section), which is illustrated in FIG. 17C. The user can provide an instruction about whether or not to approve a transfer of deposit from the transaction account AC1 to the fund transfer account AC2, by tapping the button B164 to enable/disable the button B164.

### (Step S155)

Next, in step S155, the user makes a final confirmation of the content of the sell order on the screen illustrated in FIG. 17C and tapping the button B162 for making a choice to place the sell order. Then, the instruction processing section 327 transmits an instruction of the order placement choice to the server 110. Based on the instruction of the order placement choice, the transaction management section 315 of the server 110 places the sell order. Further, the transaction management section 315, if there is a buy order of a reverse transaction for the sell order, effects a transaction for matching the buy order and the sell order to establish an agreement of the user's sell order and ends the transaction relating to the sell order. As described above, the processing in step S155 corresponds to an example of the “step of placing the sell order and establishing an agreement of the sell order” in the present disclosure.

### (Steps S156 and S157)

Subsequently, in step S156, the transaction management section 315 and the fund processing section 317 of the server 110 asks the user about whether or not to approve a transfer of the deposit from the transaction account AC1 to the fund transfer account AC2. Here, it should be understood that a comprehensive approval may be obtained in advance from the user to prevent asking for the user's approval for each transaction. In this case, the user's operation is further simplified, and as a result, a load on the information processing terminal can be reduced. Then, in step S157, if the user's approval of the deposit transfer has been obtained in step S156 (Yes in step S156), the transaction management section 315 and the fund processing section 317 of the server 110 transfer a part or all of the deposit including the payment of the sell order agreed in step S155 from the transaction account AC1 to the fund transfer account AC2.

As described above, the processing in step S157 corresponds to an example of the “step of transferring a part or all of the deposit” in the present disclosure. Further, the control section 313 including the transaction management section 315 and the fund processing section 317 in the server 110 corresponds to an example of the “fund transfer section” in the present disclosure. Note that in order to enable the user to designate the amount of the deposit to be transferred, for example, a column and a numeric keypad for entering the amount may be displayed or a list of a plurality of candidate amounts may be displayed. Thereby, a choice can be made therefrom (each of these examples is not illustrated) may be displayed on the screen illustrated in FIG. 17C.

On the other hand, if the user's approval of deposit transfer has not been obtained in step S156 (No in step S156), the transaction management section 315 of the server 110 ends a series of steps of the processing without performing the deposit transfer.

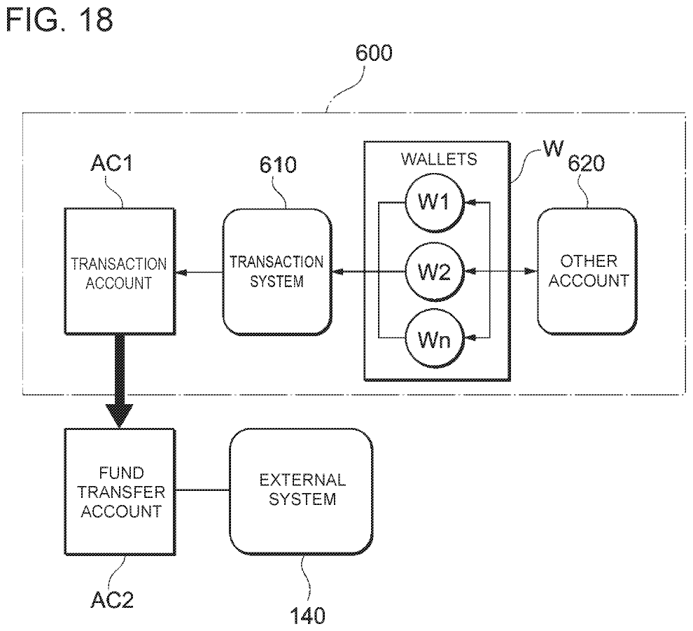

Here, FIG. 18 conceptually illustrates an example of a processing flow in an information processor according to the second embodiment. As illustrated in the figure, the sell order in the above-described virtual currency buy/sell transaction is placed with a virtual currency exchange 600 by an electro transaction system 610 built by the server 110, which is an information processor 200. As already described with reference to the flow of the processing in FIG. 16, upon the agreement of the sell order, the payment for the sell order is appropriated as the deposit in the transaction account AC1. Based on the user's approval, a part or all of the deposit is transferred from the transaction account AC1 to the fund transfer account AC2 (indicated by the bold arrow directed from the transaction account AC1 to the fund transfer account AC2 in FIG. 18).

Also, the virtual currency held by the user is temporarily stored in, for example, a wallet W (wallets W1, W2, . . . , Wn are provided for respective virtual currencies), which is a web wallet (exchange wallet). However, the virtual currency stored in the wallet W can appropriately be, for example, transferred, withdrawn or moved to another account held by the user (including another wallet), the other account being different from the transaction account AC1, or an account held by a party other than the user. Conversely, virtual currency can appropriately be, for example, transferred, deposited or moved from such other account to the wallet W.

### First Example

A first example of the second embodiment is an example in which virtual currency that is not virtual currency originally held by a user but, as described above, virtual currency transferred from another account of another user (that is, virtual currency assigned regardless of whether with or without compensation) is sold. Further, for example, a deposit amount corresponding to payment of the selling in a deposit including the payment of the selling in the transaction account AC1, the deposit is transferred from a transaction account AC1 to a fund transfer account AC2.

### Effects of the First Example

According to the first example of the second embodiment, what is to be sold is virtual currency assigned from another user, which is thus a temporarily-held property, enabling a fund in a fund transfer account AC2 to be increased with simple processing without affecting, e.g., a portfolio of virtual currency held and managed by a user.

### Operation and Processing in the First Example

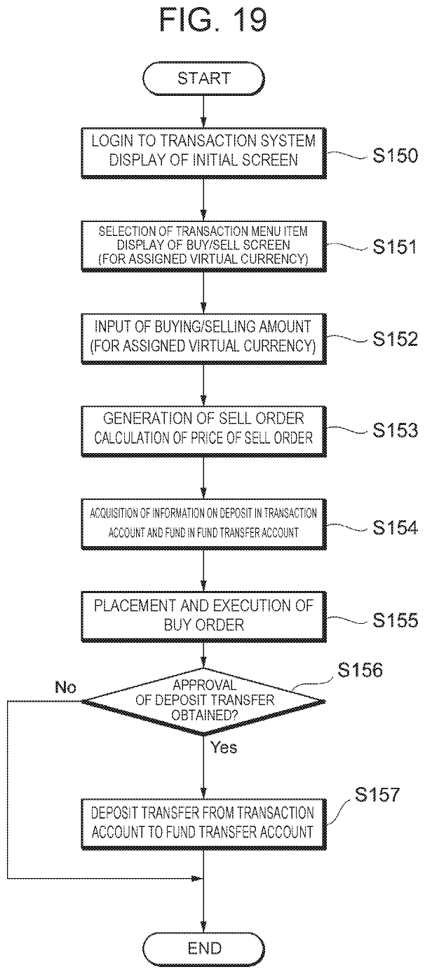

FIG. 19 illustrates an example of a flowchart of processing in the information processor according to a first example of the second embodiment. FIG. 19 also indicates a flow illustrating an example of a processing procedure in an information processing method according to the present disclosure. As illustrated in the figure, processing in the first example of the second embodiment is performed in a procedure that is equivalent to that of the second embodiment illustrated in FIG. 16, except that: in step S151, virtual currency assigned from another user is selected as a subject of the sell order; and in step S152, an amount of the assigned virtual currency is designated and input.

### Second Example

A second example of the second embodiment is an example in which a user's approval of transfer of a fund from a transaction account AC1 to a fund transfer account AC2 is obtained in advance prior to sell orders. Further, if an agreement of the sell order is established, a deposit is automatically transferred without obtainment of the user's approval for each sell order.

### Effects of the Second Example

According to the second example of the second embodiment, a user's approval of fund transfer is obtained in advance, enabling a deposit in a transaction account AC1 to be quickly transferred to a fund transfer account AC2 without obtainment of the user's approval of deposit transfer for each sell order. Consequently, a sell order can further smoothly be placed and processing time can further be reduced. Therefore, a user's stress can be further reduced and a desired transaction can be performed at a more proper timing.

### Operation and Processing in the Second Example

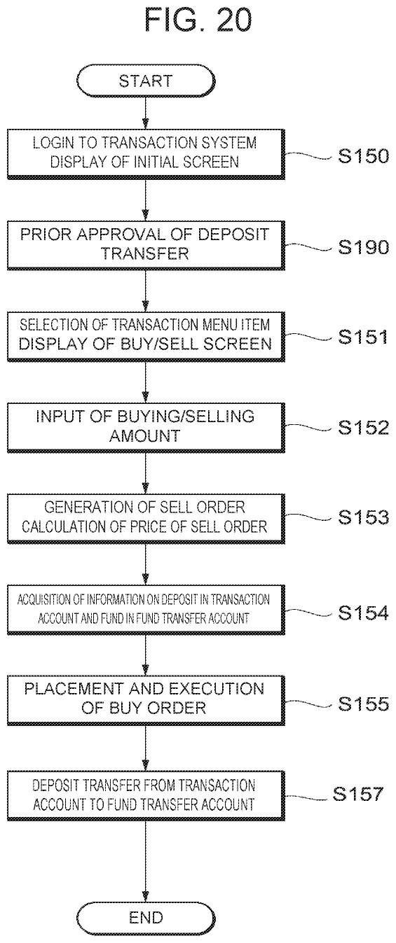

FIG. 20 illustrates an example of a flowchart of processing in the information processor according to the second example of the second embodiment. FIG. 20 also indicates a flow illustrating an example of a processing procedure in an information processing method according to the present disclosure. As illustrated in the figure, in the second example of the second embodiment, processing is performed in a procedure that is equivalent to that of the second embodiment illustrated in FIG. 16, except that: step S190 is performed between step S150 in which a user logins to an electro transaction system and an initial screen is displayed and step S151 in which a transaction menu item is selected; and step S156 is not included.

In step S190, first, a user selects a menu item for initial setting from among menu items for handling and setting a deposit (including agreed payment of a sell order) in a transaction account AC1. Then, a transaction management section 315 and a display processing section 318 of a server 110 generate image data for inputting a setting for whether or not to approve a deposit transfer from the transaction account AC1 to a fund transfer account AC2 and transmits the image data to a terminal 120. Based on the image data, a display processing section 328 of the terminal 120 provides display of an initial setting screen that enables making a setting of whether or not to approve a deposit transfer on an input/output I/F 321 (output section).

If such initial setting of approval of deposit transfer is registered, in step S157 illustrated in FIG. 20, the transaction management section 315 and the fund processing section 317 of the server 110 perform a deposit transfer from the transaction account AC1 to the fund transfer account AC2 without obtainment of the user's approval deposit transfer for each time.

### Third Example

A third example of the second embodiment is an example in which where a balance of a fund in a fund transfer account AC2 is insufficient for a predetermined value, if an agreement of a sell order has been established and the user's approval of deposit transfer has been obtained, a part or all of a deposit in a transaction account AC1 is transferred to the fund transfer account AC2.

### Effects of the Third Example

According to the third example of the second embodiment, a balance of a fund in a fund transfer account AC2 is sufficient, the need for perform an unnecessary deposit transfer is eliminated. Thereby, a load of management of the fund in the fund transfer account AC2 by a user can be reduced, enabling further enhancement in convenience of a transaction service.

### Operation and Processing in the Third Example

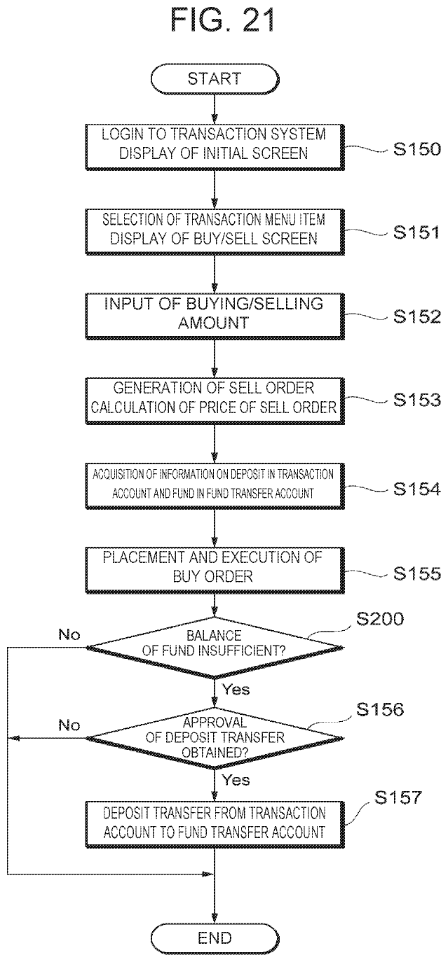

FIG. 21 illustrates an example of a flowchart of processing in the information processor according to the third example of the second embodiment. FIG. 21 also indicates a flow illustrating an example of a processing procedure in an information processing method according to the present disclosure. As illustrated in the figure, in the third example of the second embodiment, processing is performed in a procedure that is equivalent to that of the second embodiment illustrated in FIG. 16, except that step S200 is performed between step S155 in which a sell order of virtual currency is placed and an agreement of the sell order is established and step S156 in which whether or not a user's approval of a deposit transfer from a transaction account AC1 to a fund transfer account AC2 has been obtained is confirmed.

In step S200, a predetermined value set for a balance of a fund of the fund transfer account AC2 and an actual fund balance of the fund transfer account AC2 as of that point of time are compared with each other. If the fund balance of the fund transfer account AC2 is insufficient for the predetermined value (Yes in step S200), the processing proceeds to step S156 for confirming whether or not the user's approval of deposit transfer has been obtained. On the other hand, if the fund balance of the fund transfer account AC2 is not insufficient for the predetermined value (No in step S200), a series of steps of the processing is ended without steps S156 and S157 being performed.

Here, the predetermined value set as a threshold value for the actual fund balance of the fund transfer account AC2 can appropriately be set by the user or the electro transaction system and may be a fixed value or a variable value. Also, as in the first embodiment, where processing for calculating a price of a buy order and appropriating the fund in the fund transfer account AC2 as a deposit in the transaction account AC1 is performed, the predetermined value may be the price of the generated buy order. In this case, the fund balance of the fund transfer account AC2 is insufficient for the buy order and thus the transaction account AC1 fails to be compensated for and there is a high need to supplement the fund in the fund transfer account AC2 with payment of selling of virtual currency.

### Fourth Example

A fourth example of the second embodiment is an example in which instead of a sell order of virtual currency, a loan of money is obtained using virtual currency as a mortgage, and borrowed money is appropriated as a fund in a fund transfer account AC2. The borrowed money loaned with virtual currency as a mortgage is temporarily appropriated as a deposit in a transaction account AC1 and then the deposit is transferred to the fund transfer account AC2 based on simple approval processing by a user.

### Effects of the Fourth Example

According to the fourth example of the second embodiment, an operating fund for, e.g., investment can be procured with virtual currency managed without being converted into money, the virtual currency being held by a user. Accordingly, the scope of management of investment assets by the user can be expanded and a margin for funds can be increased.

### Operation and Processing in the Fourth Example

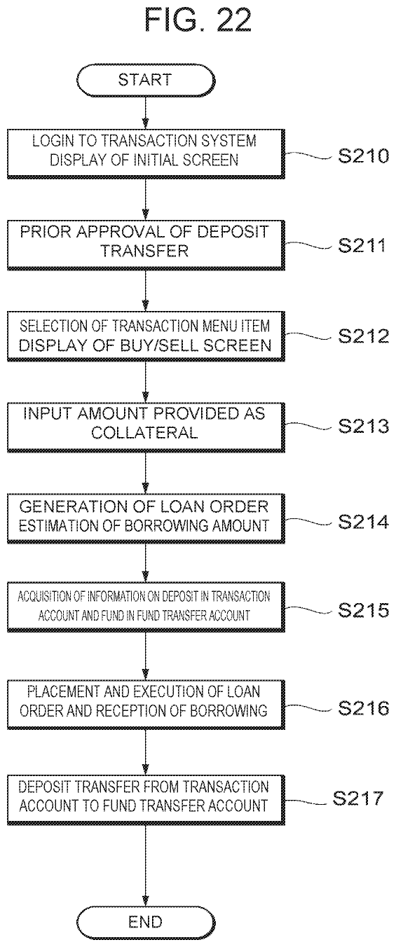

FIG. 22 illustrates an example of a flowchart of processing in the information processor according to the fourth example of the second embodiment. FIG. 22 also indicates a flow illustrating an example of a processing procedure in an information processing method according to the present disclosure.

First, in step S210, as in the processing in step S150, a user logins to an electro transaction system and causes an initial screen to be displayed on a terminal 120. Next, in step S211, as in the processing in step S190, a menu item for initial setting from among menu items for handling/setting of a deposit in a transaction account AC1. Further, an initial setting for approval of deposit transfer is registered via an initial setting screen that enables setting of whether or not to approve deposit transfer to be made in the terminal 120. Next, in step S212, from among various transaction menu items, a mortgage loan screen for applying a loan of money with virtual currency as a mortgage is displayed. Next, in step S213, a kind of the virtual currency provided as a mortgage and an amount of the virtual currency provided as a mortgage are input.

Furthermore, in step S214, based on the information input for the mortgage loan and information in an external database relating to, e.g., a mortgage value of the virtual currency, a transaction management section 315 and an order processing section 316 of a server 110 generate a loan order and calculate an estimated value of borrowed money (loaned money) that is likely to be loaned at the current point of time. The transaction management section 315 and a display processing section 318 of the server 100 generate image data for presenting such information relating to the loan to the user and transmit the image data to the terminal 120. Based on the image data, a display processing section 328 of the terminal 120 provides display of a screen that presents the information relating to the loan.

Also, in step S215, as in the processing in step S154, the transaction management section 315 and a fund processing section 317 of the server 110 read information on a deposit in a transaction account AC1 and information on a fund in a fund transfer account AC2 as of the current point of time from a storage section 314. Furthermore, the transaction management section 315 and the display processing section 318 of the server 110 generate image data for displaying the deposit in the transaction account AC1 and the fund in the fund transfer account AC2 and transmit the image data to the terminal 120. Based on the image data, the display processing section 328 provides display of (a balance of) the deposit in the transaction account AC1 and (a balance of) the fund in the fund transfer account AC2.

Next, in step S216, the user confirms the information relating to the loan and the information on the deposit in the transaction account AC1 and the fund in the fund transfer account AC2 and places the loan order from the terminal 120. If the loan order satisfies a predetermined condition and thus is approved and the borrowed money is received by the electro transaction system, the borrowed money is temporarily appropriated as the deposit in the transaction account AC1. Subsequently, in step S217, since the user's approval of deposit transfer has been obtained in advance, the transaction management section 315 and the fund processing section 317 of the server 110 transfer a part or all of the deposit including the borrowed money loaned with the virtual currency as a mortgage, from the transaction account AC1 to the fund transfer account AC2.

As described above, the processing in step S214 corresponds to an example of the “step of generating a loan order” in the present disclosure. Also, the processing in step S216 corresponds to an example of the “step of placing the loan order and appropriating loaned money as a deposit” in the present disclosure.

### Fifth Example

A fifth example of the second embodiment is an example in which a price of a fund transferred between a transaction account AC1 and a fund transfer account AC2 is determined according to a rate for a transaction made using the transaction account AC1. Where the transaction is a virtual currency transaction, it is known that the price largely varies even during a short period of time. Therefore, the price varies depending on the timing of determination of the rate, and the transaction may be made at a price not intended by a user.

### Effects of the Fifth Example

According to the fifth example of the second embodiment, a rate can be determined at a proper timing, enabling a fund to be prevented from being transferred between a transaction account AC1 and a fund transfer account AC2 at a price not intended by a user.

### Operation and Processing in the Fifth Example

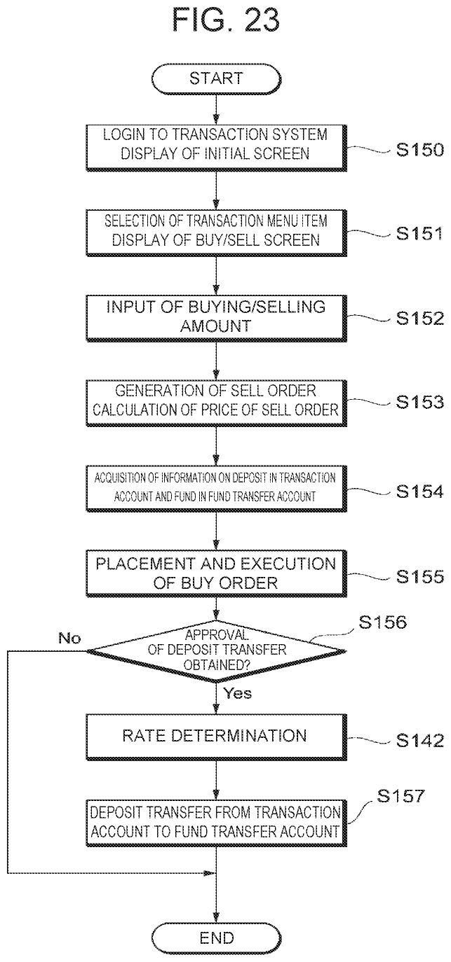

FIG. 23 illustrates an example of a flowchart of processing in the information processor according to the fifth example of the second embodiment. FIG. 23 also indicates a flow illustrating an example of a processing procedure in an information processing method according to the present disclosure. As illustrated in the figure, in the fifth example of the second embodiment, processing is performed in a procedure that is equivalent to that of the second embodiment illustrated in FIG. 16, except that in a step S142, a price of a fund to be transferred between a transaction account AC1 and a fund transfer account AC2 is determined according to a rate for a transaction made using the transaction account AC1.

For example, where an approval of fund transfer from a user is obtained for each transaction as in the second embodiment illustrated in FIG. 16, a method in which a rate is determined at the time of obtainment of the approval and a method in which a rate that is an average value or a center value of rates during a predetermined period of time from the obtainment of the approval (a fixed period of time set in advance or a period of time until the fund transfer is actually performed) is determined are conceivable.

Also, as in the second example of the second embodiment illustrated in FIG. 20 and the fourth example of the second embodiment illustrated in FIG. 22, where an approval of fund transfer from a user is obtained in advance (a comprehensive approval is obtained), a method in which a rate as of the time when a fund transfer was actually performed is determined as the rate. Further, examples of such method include a method in which based on information on a time, the information being acquired by a terminal 120 and transmitted to a server 110, the server 110 employs a rate as of that time and a method in which a server employs a rate as of the time when the server 110 received an instruction for the fund transfer.

### Third Embodiment

A third embodiment is an embodiment illustrating an example of application of the present disclosure to a service that allows a user to make a buy/sell transaction of a transaction subject online via a network 130, using a terminal 120. In the third embodiment, as in the first embodiment (see FIG. 3), for example, an electro transaction system 610 for making a buy/sell transaction of a transaction subject is built by a server 110. A user transmits a desired buy order to the electro transaction system 610 from a terminal 120 through the network 130. The electro transaction system 610 places the buy order with a predetermined exchange and establishes an agreement of buying of the transaction subject. Also, in order to use the service provided by the electro transaction system 610, a transaction account AC1 is opened for each user. The user can use a deposit in the transaction account AC1 for payment of the buy order of the transaction subject. Furthermore, in placing a buy order, based on the user's approval on the electro transaction system 610, a fund can be transferred from a fund transfer account AC2 that is different from the transaction account AC1, to the transaction account AC1 and appropriated for the payment. The fund transfer account AC2 is an account that is different from the transaction account AC1, which is a withdrawal source account for the electro transaction system 610, and a fund from an external system 140 such as a financial institution can appropriately be appropriated to the fund transfer account AC2.

In the third embodiment, in placing a buy order, a user designates a buying amount of a transaction subject using a slider. The slider enables a fund to be used for a buy order to be designated across a balance of a transaction account AC1 and a balance of a fund transfer account AC2. In more detail, the slider according to the third embodiment can receive designation of a buying amount of a transaction subject and enables specifying an amount of a fund in the fund transfer account AC2 to be deposited in a transaction account AC1 and thereby appropriated for payment of buying of virtual currency. Here, the slider only needs to be one that enables a range in which an amount of the transaction subject can be designated to be determined based on a total of the balance of the transaction account AC1 and the balance of the fund transfer account AC2. Further, the slider is not limited to a linear one and may be any type of object as long as the area of the object can be adjusted. Examples of the slider include, but not limited to, objects each having a shape such as a round shape, a circular arc shape or a polygonal shape. Also, accounts across which designation via a slider is allowed not necessarily need to be a transaction account AC1 and a single fund transfer account AC2 but may be a transaction account AC1 and a plurality of fund transfer accounts AC2.

### Effects of the Third Embodiment

According to the third embodiment, a user can designate a buying amount of a transaction subject, and specify an amount of a fund in a fund transfer account AC2 to be deposited in a balance of a transaction account AC1 using a slider. Consequently, botheration a user conventionally has in a deposit/withdrawal operation (in particular, a deposit operation) can be removed. Accordingly, a smooth buy/sell transaction of a transaction subject can be implemented. In other words, according to the third embodiment, a conventional procedure or operation necessary for transfer of money between a transaction account AC1 and a financial account can be reduced, enabling a buy/sell transaction of a transaction subject to be made “smoothly” by a seamless operation in an electro transaction system. As a result, the number of operations by a user is decreased and stress is thus reduced, enabling enhancement in user convenience. Also, the user's willingness for a buy/sell transaction can be maintained. Furthermore, the user can make a buy/sell transaction at a desired timing without missing a chance for the transaction.

### (1) Configuration of the Server

A configuration of the server 110 in the third embodiment is equivalent to the configuration of the server 110 in the first embodiment, and thus, detailed description thereof will be omitted here.

### (2) Configuration of the Terminal

A configuration of the terminal 120 in the third embodiment is equivalent to the configuration of the terminal 120 in the first embodiment, and thus, detailed description thereof will be omitted here.

### Operation and Processing in the Third Embodiment

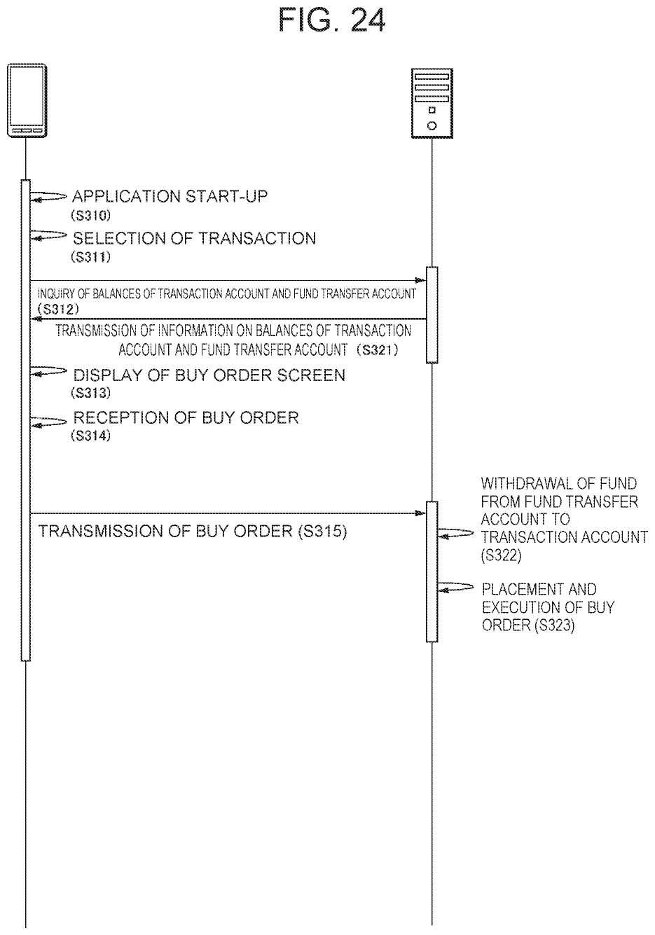

Processing in the electro transaction system 610 according to the present embodiment will be described with reference to FIG. 24. FIG. 24 illustrates an example of a sequence diagram of processing in the server 110 and the terminal 120 according to the third embodiment. FOG. 24 also indicates a diagram illustrating an example of a processing procedure in an information processing method according to the present disclosure. Note that the below-described processing procedure is a mere example and each of the steps of processing may be changed as long as such change is possible within the scope of the technical idea of the present disclosure and appropriate omission, replacement and addition of steps are possible. In the below, description will be provided mainly on differences from the processing flow described with reference to FIG. 5 in the first embodiment.

### (Step S310)

First, a user executes an electro transaction system application (program). Note that the processing in step S310 is similar to the processing in step S40 described with reference to FIG. 5 in the first embodiment, and thus, detailed description thereof will be omitted.

### (Step S311)

Upon the user executing the electro transaction system application and logging in to the electro transaction system, the screen can be made to transition to a screen that enables selection of a transaction. Selection of a transaction refers to, for example, selection of a kind of a transaction subject and/or selection of a content of an order (for example, whether a buy order or a sell order). Here, description will be provided on the assumption that the user selects a buy order of a predetermined kind of virtual currency.

### (Steps S312 and S313)

Upon selection of a buy order in the terminal 120, the terminal 120 inquires the server 110 about balances of a transaction account AC1 and a fund transfer account AC2 of the user that is logging in (S312). The server 110 refers to a storage section 314 and acquires balance information of the transaction account AC1 and the fund transfer account AC2 associated with the user, the balance information responding to the inquiry, and returns the balance information to the terminal 120 (S321).

### (Steps S313 to S315)

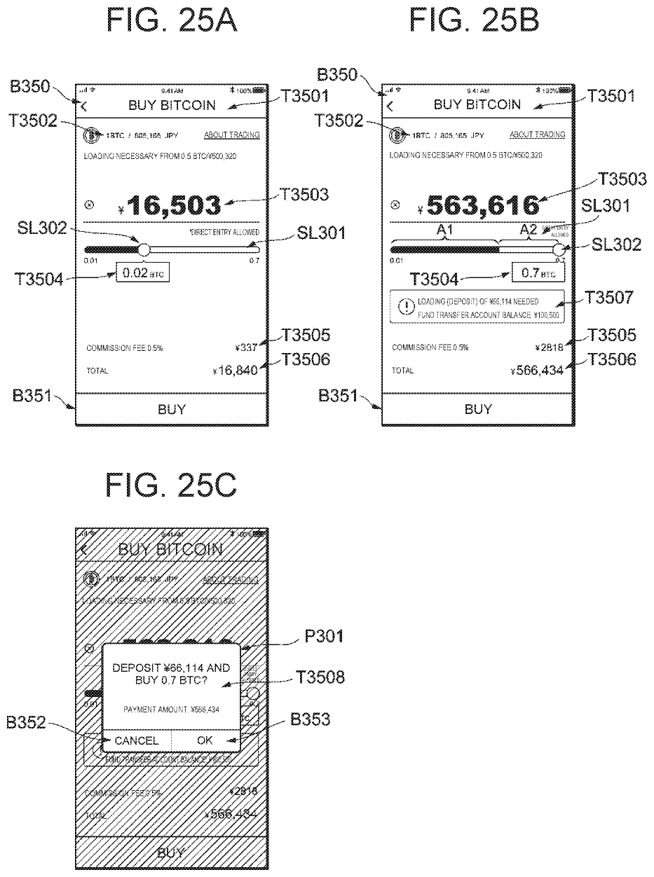

Upon reception of the balance information by the terminal 120, a display processing section 328 provides display of an order screen for placing a buy order (S313). Here, an example of the order screen displayed when the user operates the terminal 120 to place a buy order will be described with reference to FIGS. 25A to 25C. FIGS. 25A to 25C each illustrate an example of an order screen according to the third embodiment.

First, in step S313, the order screen illustrated in FIG. 25A is displayed on the terminal 120. The display processing section 328 provides display of a text T3501 indicating that the selected menu item is a menu item for buying the selected virtual currency, a button B350 for returning to a previous menu, a text T3502 indicating a current unit buying price, a text T3503 indicating a Japanese yen equivalent of a currently-designated amount of the virtual currency, a slider SL301 and a handle SL302 for designating a buying amount of the virtual currency, a text T3504 indicating the buying amount of the virtual currency, a text T3505 indicating a commission fee required for the buy order, a text T3506 indicating an amount of Japanese yen necessary for purchasing the designated amount of the virtual currency, and a button B351 for selecting buying of the virtual currency, in the order from the upper part to the lower part of the order screen illustrated in FIG. 25A.

Below the slider SL301, a minimum value and a maximum value of the virtual currency that can be designated are displayed. In the example in FIG. 25A, the minimum value and the maximum value are indicated in amount of virtual currency; however, the present disclosure is not limited to this example and the minimum value and the maximum value may be indicated in Japanese yen equivalent. Also, the maximum value is preferably an amount of virtual currency that can be bought with a total of the balance of the transaction account AC1 and the balance of the fund transfer account AC2. More preferably, the maximum value is an amount of virtual currency that can be bought with an amount of the total with the commission fee subtracted therefrom.

When the user wishes to buy the virtual currency, the user adjusts a position of the handle SL302 in the slider SL301 to designate an amount of the virtual currency the user wishes to buy. Based on the designated amount of virtual currency, a transaction management section 325 calculates a Japanese yen equivalent thereof. The calculated Japanese yen equivalent is displayed as the text T3503 on the order screen. Note that when the designated amount of the virtual currency is converted into Japanese yen, if the Japanese yen includes a fraction, the display processing section 328 preferably causes the handle SL302 to stick to an amount that does not include a fraction even if the amount is converted into Japanese yen. The fraction may be, for example, an amount after the decimal point or an amount in places (or digits) that are equal to or lower than a predetermined place (or digit). The example illustrated in FIG. 25A indicates the case where the fraction is an amount after the decimal point.

If the Japanese yen equivalent of the amount of virtual currency designated by the user exceeds the balance of the transaction account AC1, in the slider SL301, transfer of the fund of the fund transfer account AC2 for appropriation of the fund for payment of the buy order is displayed in a visually-recognizable manner. For example, in the example in FIG. 25B, an amount range A1 (first area) of virtual currency that can be bought with the balance of the transaction account AC1 and an amount range A2 (second area) in which the fund in the fund transfer account AC2 is appropriated for the payment are displayed in different colors. However, if the fund in the fund transfer account AC2 is deposited in the transaction account AC1 and appropriated for the payment, a text T3507 for calling for the user's attention is preferably displayed. Note that the user can directly edit the text T3503 to designate the buying amount of virtual currency in a Japanese yen equivalent. In this case, the handle SL302 preferably automatically moves to a position of an amount of the virtual currency converted from the Japanese yen amount input in texts in the slider SL301. Note that the slider SL301 only needs to include the amount range A1 (first area) of virtual currency that can be bought with the balance of the transaction account AC1 and the amount range A2 (second area) in which the fund in the fund transfer account AC2 is appropriated for the payment. Further, the range A1 and the range A2 do not necessarily need to be displayed in a visually recognizable manner.

Upon the user tapping the button B351 for providing notification of completion of the input of the buying amount of virtual currency, an order processing section 326 receives a buy order for the input amount (S314). At this time, if use of the fund in the fund transfer account AC2 is designated for a buy order, the display processing section 328 provides display of an approval screen for obtaining an approval of depositing of the fund in the fund transfer account AC2 into the transaction account AC1 from the user. FIG. 25C illustrates an example of the approval screen. In the example in FIG. 25C, the approval screen is displayed as a pop-up P301. In the pop-up P301, a text T3508 for obtaining an approval of depositing of the fund in the fund transfer account AC2 into the transaction account AC1 from the user, a cancel button B352 and an OK button B353 are displayed. In the pop-up P301, if the cancel button B352 is selected, the order processing section 326 cancels the received buy order and the display processing section 328 displays the order screen illustrated in FIG. 25A, again.

On the other hand, if the OK button B353 is selected, the order processing section 326 transmits the received buy order to the server 110 (S315). The buy order is information including, for example, at least information for identifying the transaction account AC1, and the amount of the virtual currency (or the Japanese yen equivalent thereof) to be bought using the balance of the transaction account AC1. If use of the fund in the fund transfer account AC2 is designated for a buy order, the buy order preferably further includes information for identifying the fund transfer account AC2, and the amount of virtual currency (or the Japanese yen equivalent thereof) to be bought using the balance of the fund transfer account AC2.

### (Steps S322 and S323)

Upon reception of the buy order, if use of the fund in the fund transfer account AC2 is designated in the buy order, an order processing section 316 of the server 110 transfers the fund in the fund transfer account AC2 to the transaction account AC1 (S322). The fund in the fund transfer account AC2 that can be transferred here is the Japanese yen equivalent of the amount of virtual currency designated in the buy order. A transaction management section 315 of the server 110 places the buy order. Further, the transaction management section 315, if there is a sell order of a reverse transaction for the buy order, effects a transaction for matching the buy order and the sell order to establish an agreement of the user's buy order, and ends the transaction relating to the buy order (S323).

Note that in the order screen illustrated in FIG. 25A, a mark may be displayed in the slider SL301 so that the amount of virtual currency that can be bought using the balance of the transaction account AC1 can be recognized. The mark is displayed at a boundary between the range A1 of the amount of virtual currency that can be bought using the balance of the transaction account AC1 and the range A2 of the amount for which the fund in the fund transfer account AC2 is appropriated as payment in the slider SL301. Note that the ranges of the slider SL301 separated by the boundary may be displayed in different colors.

### First Example

A first example of the third embodiment is an example in which an operation interface that enables appropriating a fund in a fund transfer account for a part of payment even if a Japanese yen equivalent of an amount of virtual currency designated by a user in a buy order is within a balance of a transaction account is displayed on a terminal 120.

### Effects of the First Example

According to the first example of the third embodiment, in placing a buy order of virtual currency, a user can designate an amount of fund appropriated from a fund transfer account, with a simple and instinctive operation. Consequently, substantive choices for a fund to be used for buying of a virtual currency can be expanded, enabling enhancement in versatility of an electro transaction system and user convenience. Furthermore, a transaction of virtual currency can “smoothly” be performed.

### Example of a Screen in the First Example

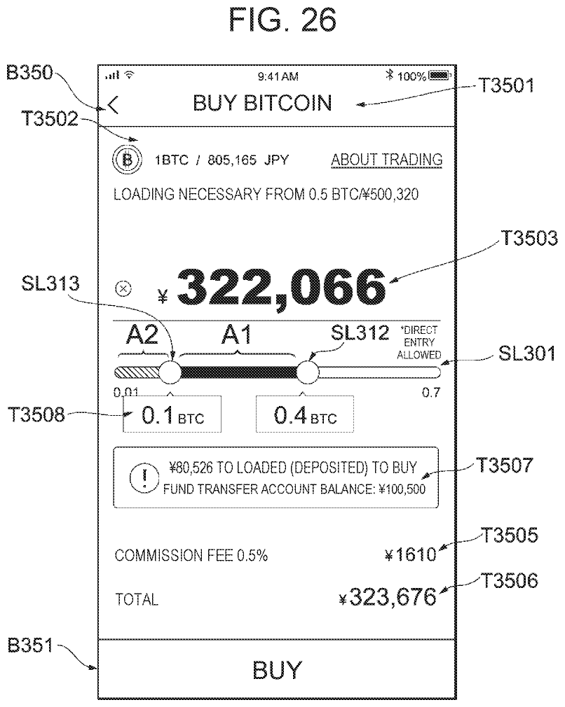

An order screen in the first example will be described with reference to FIG. 26. FIG. 26, which corresponds to FIG. 25B, illustrates an order screen on which a slider for designating a buying amount of virtual currency in a buy order is displayed. Here, components that are equivalent to those in FIG. 25B are provided with reference numerals that are the same as those in FIG. 25B, and differences from the screen in FIG. 25B will be described.

A slider SL301 according to the first example of the third embodiment includes handles SL312, SL313 instead of the handle SL302 in FIG. 25B. The handle SL312, which corresponds to the handle SL302 in FIG. 25B, receives designation of an amount of virtual currency to be bought via a buy order. On the other hand, the handle SL313 designates an amount in an amount of virtual currency designated via the handle SL302, a fund in a fund transfer account being appropriated for payment of the amount. In FIG. 26, a buying amount of virtual currency designated by the handle SL312 is divided into a range A2 and a range A1 by the handle SL313. The amount designated by the range A2 corresponds to an amount of virtual currency to be bought with a balance of a fund transfer account AC2, and the amount designated by the range A1 corresponds to an amount of virtual currency to be bought with a balance of a transaction account AC1. In other words, in FIG. 26, the fund in the fund transfer account is appropriated for payment for buying the amount of virtual currency, the amount corresponding to the range A2 (0.1 [BTC] in this example), and the balance of the transaction account is used for buying of the amount of virtual currency, the amount corresponding to the range A1 (0.4-0.1 [BTC] in this example).

### Second Example

A second example of the third embodiment is an example in which for a slider for a user to designate a buying amount of virtual currency in a buy order, an amount of virtual currency that can be bought with a balance of a transaction account and an amount of virtual currency that can be bought by appropriation of a fund in a fund transfer account are displayed in texts.

### Effects of the Second Example

According to the second example of the third embodiment, in placing a buy order of virtual currency, a user can designate an amount of fund appropriated from a fund transfer account, with a simple and instinctive operation. Consequently, substantive choices for a fund to be used for buying of a virtual currency can be expanded, enabling enhancement in versatility of an electro transaction system and user convenience, and a transaction of virtual currency can “smoothly” be performed.

### Example of a Screen in the Second Example

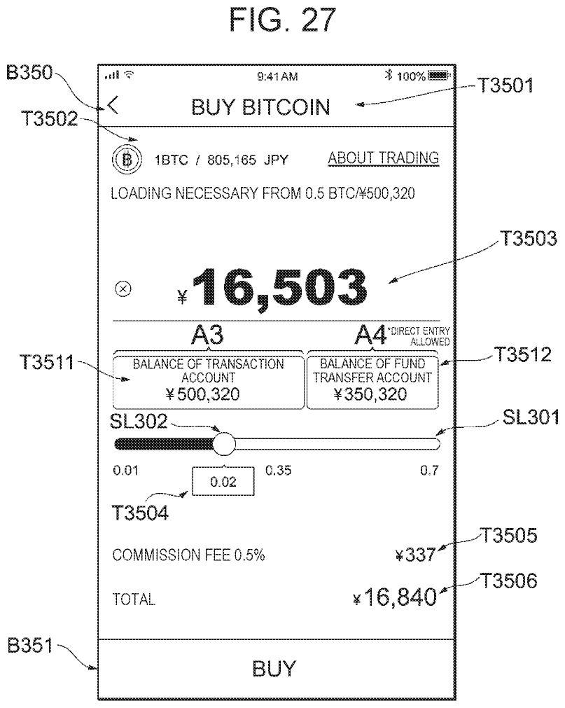

An order screen in the second example will be described with reference to FIG. 27. FIG. 27, which corresponds to FIG. 25B, illustrates a screen on which a slider for designating a buying amount of virtual currency in a buy order is displayed. Here, components that are equivalent to those in FIG. 25B are provided with reference numerals that are the same as those in FIG. 25B, and differences from the screen in FIG. 25B will be described.

Above the slider SL301 in the second example, a chart C301 having a width that is the same as that of the slider SL301 is displayed. The chart C301 includes an area A3 and an area A4, and respective proportions of the areas A3, A4 in the chart C301 indicate respective proportions of a balance of a transaction account and a balance of a fund transfer account in a total of the balances. In other words, in the example in FIG. 27, in the slider SL301, for an amount of virtual currency until the handle SL302 reaches a boundary between the range A3 and the range A4, the amount of virtual currency can be bought using the balance of the transaction account. On the other hand, for an amount beyond the boundary, the fund in the fund transfer account needs to be appropriated for payment of the buying.

### Fourth Embodiment

A fourth embodiment is an embodiment indicating an example of application of the present disclosure to a service that allows a user to make a buy/sell transaction of a transaction subject online via a network 130, using a terminal 120. In the third embodiment, as in the second embodiment (see FIG. 15), for example, an electro transaction system 610 for making a buy/sell transaction of a transaction subject is built by a server 110 and a user transmits a desired buy/sell order to the electro transaction system from a terminal 120 through the network 130. Further, the electro transaction system places the buy/sell order with a predetermined exchange and establishes an agreement of buying and selling of the transaction subject. In order to use the service provided by the electro transaction system 610, a transaction account AC1 is opened for each user, and the user can appropriate agreed payment of the sell order of the transaction subject, the agreed payment being held by the user, as a deposit in the transaction account AC1. Furthermore, based on the user's approval on the electro transaction system 610, the deposit in the transaction account AC1 can appropriately be transferred to a fund transfer account AC2 that is different from the transaction account AC1.

In the fourth embodiment, in placing a sell order, a user designates a selling amount of a transaction subject using a slider. The slider enables designating an amount in payment of a sell order, the amount being appropriated to a transaction account AC1, and an amount in the payment of the sell order, the amount being appropriated to a fund transfer account AC2. For more detail, the slider according to the fourth embodiment can receive designation of a selling amount of a transaction subject and enables specifying an amount of a fund to be transferred from a balance of the transaction account AC1 to the fund transfer account AC2. Here, the slider only needs to be one that enables a range in which an amount of the transaction subject can be designated to be determined based on an amount of the transaction subject held by the user, and is not limited to a linear one and may be any type of object as long as the area of the object can be adjusted. Examples of the slider include, but not limited to, sliders each having a shape such as a round shape, a circular arc shape or a polygonal shape. Also, accounts across which the slider is provided is not limited to a transaction account AC1 and a single fund transfer account AC2 but may be a transaction account AC1 and a plurality of fund transfer accounts AC2.

### Effects of the Fourth Embodiment

According to the fourth embodiment, a user can designate a selling amount of a transaction subject, and specify an amount of a fund to be transferred from a balance of a transaction account AC1 to a fund transfer account AC2 using a slider. Consequently, botheration a user conventionally has in a deposit/withdrawal operation (in particular, a withdrawal operation) can be removed, enabling enhancement in convenience of a transaction service and thus enabling enhancement in quality of the service for a user. In other words, according to the second embodiment, a conventional procedure or operation necessary for transfer of money from a transaction account to, e.g., a financial account or a withdrawal source account for use of another external service is eliminated, enabling a buy/sell transaction of a transaction subject or use of an external system to be made “smoothly” by a seamless operation in an electro transaction system or the external system. As a result, the number of operations by a user is decreased and stress is thus reduced, enabling enhancement in user convenience. Also, the user's willingness for a buy/sell transaction and use of the external system can be maintained. Furthermore, the user can make a buy/sell transaction at a desired timing without missing a chance for the transaction.

### (1) Configuration of the Server

A configuration of the server 110 in the fourth embodiment is equivalent to the configuration of the server 110 in the first embodiment, and thus, detailed description thereof will be omitted here.

### (2) Configuration of the Terminal

A configuration of the terminal 120 in the fourth embodiment is equivalent to the configuration of the server 110 in the first embodiment. However, a configuration in which wallets W are managed by the terminal 120 may be employed.

### Operation and Processing in the Fourth Embodiment

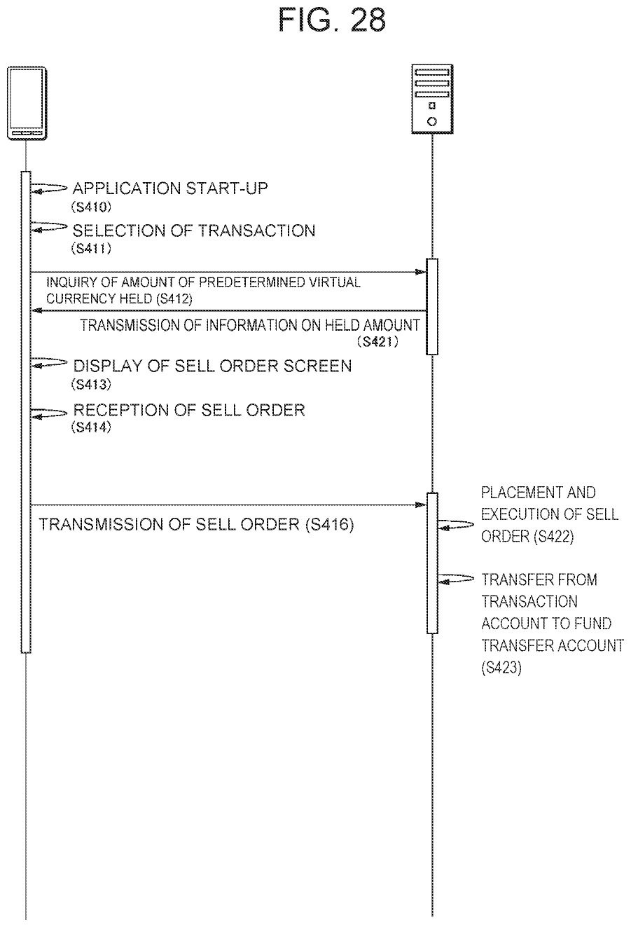

Processing in the electro transaction system 610 according to the present embodiment will be described with reference to FIG. 28. FIG. 28 illustrates an example of a sequence diagram of processing in the server 110 and the terminal 120 according to the fourth embodiment. FIG. 28 also indicates a diagram illustrating an example of a processing procedure in an information processing method according to the present disclosure. Note that the below-described processing procedure is a mere example and each of the steps of processing may be changed as long as such change is possible within the scope of the technical idea of the present disclosure and appropriate omission, replacement and addition of steps are possible. In the below, description will be provided mainly on differences from the processing flow described with reference to FIG. 16 in the second embodiment.

### (Step S410)

First, a user executes an electro transaction system application (program). Note that the processing in step S410 is similar to the processing in step S150 described with reference to FIG. 16 in the second embodiment, and thus, detailed description thereof will be omitted.

### (Step S411)

Upon the user executing the electro transaction system application and logging in to the electro transaction system, the screen can be made to transition to a screen that enables selection of a transaction. Selection of a transaction refers to, for example, selection of a kind of a transaction subject and/or selection of a content of an order (for example, whether a buy order or a sell order). Here, description will be provided on the assumption that the user selects a sell order of a predetermined kind of virtual currency held by the user.

### (Steps S412 and S413)

Upon selection of a sell order in the terminal 120, the terminal 120 inquires the server 110 about an amount of the predetermined kind of virtual currency held by the user that is logging in (S412). The server 110 refers to a storage section 314 and acquires information on the held amount of the predetermined kind of virtual currency associated with a wallet W associated with the user corresponding to the inquiry and returns the information to the terminal 120 (S321). Note that if a configuration in which wallets W are managed in the terminal 120 is employed, the processing in steps S412 and S413 is not performed. Instead, the terminal 120 refers to a storage section 324 and acquires information on the held amount of the predetermined kind of virtual currency from a wallet W managed by the user.

### (Steps S413 to S415)

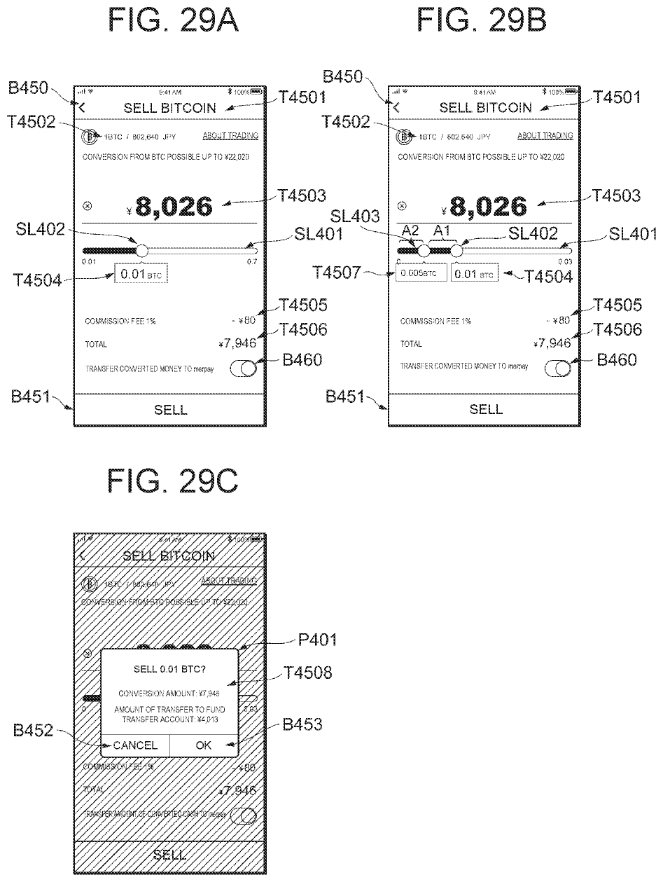

Upon acquisition of the held amount information by the terminal 120, a display processing section 328 displays an order screen for placing a sell order (S413). Here, an example of the order screen displayed when the user operates the terminal 120 to place a buy order will be described with reference to FIGS. 29A to 29C. FIGS. 29A to 29C each illustrate an example of an order screen according to the fourth embodiment.

First, in step S413, the order screen illustrated in FIG. 29A is displayed on the terminal 120. The display processing section 328 provides display of a text T4501 indicating that the selected menu item is a menu item for selling the selected virtual currency, a button B450 for returning to a previous menu, a text T4502 indicating a current unit selling price, a text T4503 indicating a Japanese yen equivalent of a currently-designated amount of the virtual currency, a slider SL401 and a handle SL402 for designating a selling amount of the virtual currency, a text T4504 indicating the selling amount of the virtual currency, a text T4505 indicating a commission fee required for the sell order, a text T4506 indicating an amount of Japanese yen necessary for selling the designated amount of the virtual currency, a button B451 for selecting selling of the virtual currency, and a button B460 for selecting whether or not to transfer a deposit in a transaction account AC1, the deposit including agreed payment of the sell order, to a fund transfer account AC2, in the order from the upper part to the lower part of the order screen illustrated in FIG. 29A.

Below the slider SL401, a minimum value and a maximum value of the virtual currency that can be designated are displayed. In the example in FIG. 29A, the minimum value and the maximum value are indicated in amount of virtual currency; however, the present disclosure is not limited to this example and the minimum value and the maximum value may be indicated in Japanese yen equivalent. Also, the maximum value is preferably the amount of the predetermined kind of virtual currency held by the user.

When the user wishes to sell the virtual currency, the user adjusts a position of the handle SL402 in the slider SL401 to designate an amount of the virtual currency the user wishes to sell. Based on the designated amount of the virtual currency, the transaction management section 325 calculates a Japanese yen equivalent thereof. The calculated Japanese yen equivalent is displayed as the text T4503 on the order screen. Note that when the designated amount of the virtual currency is converted into Japanese yen, if the Japanese yen include a fraction, the display processing section 328 preferably causes the handle SL402 to stick to an amount that does not include a fraction even if the amount is converted into Japanese yen. The fraction may be, for example, an amount after the decimal point or an amount in places that are equal to or lower than a predetermined place. The example illustrated in FIG. 29A indicates the case where the fraction is an amount after the decimal point.

If transfer of a deposit in the transaction account AC1, the deposit including agreed payment of a sell order, to the fund transfer account AC2 has been approved in the button B460, a handle SL403 in addition to the handle SL402 is displayed in the slider SL401 (FIG. 29B). The handle SL403 designates an amount of the virtual currency in the amount of the virtual currency designated by the handle SL402, money gained from selling of the amount of the virtual currency being withdrawn to the fund transfer account AC2. In FIG. 29B, the selling amount of the virtual currency designated by the handle SL402 is divided into a range A2 and a range A1 by the handle SL403. The amount designated by the range A2 corresponds to the amount of the virtual currency, the money gained from selling of the amount of the virtual currency being appropriated to the fund transfer account AC2, and the amount designated by the range A1 corresponds to an amount of the virtual currency, money gained from selling the amount of the virtual currency being appropriated to the transaction account AC1. In other words, in FIG. 29B, the amount of money gained from selling the amount of the virtual currency corresponding to the range A2 (0.005 [BTC] in this example) is withdrawn from the transaction account AC1 to the fund transfer account AC2, and the amount of money gained from selling of the amount of the virtual currency corresponding to the range A1 (0.01-0.005 [BTC] in this example) is appropriated to the transaction account AC1.

Upon the user tapping the button B451 for providing notification of completion of the input of the selling amount of the virtual currency, an order processing section 326 receives a sell order for the input amount (S414). At this time, if withdrawal of a balance of the transaction account AC1 to the fund transfer account AC2 is designated for a sell order, the display processing section 328 provides display of an approval screen for obtaining an approval of withdrawal of the balance of the transaction account AC1 to the fund transfer account AC2 from the user. FIG. 29C illustrates an example of the approval screen. In the example in FIG. 29C, the approval screen is displayed as a pop-up P401. In the pop-up P401, a text T4508 for obtaining an approval of withdrawal of the balance of the transaction account AC1 to the fund transfer account AC2 from the user, a cancel button B452 and an OK button B453 are displayed. In the pop-up P401, if the cancel button B452 is selected, the order processing section 326 cancels the received sell order and the display processing section 328 displays the order screen illustrated in FIG. 29A, once again.

On the other hand, if the OK button B453 is selected, the order processing section 326 transmits the received sell order to the server 110 (S415). The sell order is information including, for example, at least information for identifying the user and the selling amount of the virtual currency (or the Japanese yen equivalent thereof). If withdrawal of the balance of the transaction account AC1 to the fund transfer account AC2 is designated for a sell order, the sell order preferably further includes the amount of the virtual currency to be withdrawn to the fund transfer account AC2 (or the Japanese yen equivalent thereof).

### (Steps S422 and S423)

Upon reception of the sell order, an order processing section 316 of the server 110 places the sell order. If there is a buy order of a reverse transaction for the sell order, the order processing section 316 of the server 110 effects a transaction for matching the buy order and the sell order to establish an agreement of the user's sell order (S422). Furthermore, if withdrawal of the balance of the transaction account AC1 to the fund transfer account AC2 is designated for the sell order, the balance of the transaction account AC1 is transferred to the fund transfer account AC2 (S423). The balance of the transaction account AC1 transferred here is the Japanese yen equivalent of the amount of the virtual currency withdrawn to the fund transfer account AC2, the amount being designated in the sell order.

The embodiments and the examples above can provide the effect of reduction of an amount of operation and an amount of communication in addition to the already-described operation and effects and thus enable enhancement in processing performance and communication speed of an electro transaction system. Also, the embodiments and the examples above enables saving and effective use of storage resources and thus enables enhancement in economic efficiency. Further, each of the embodiments and the examples has been described in detail as an example of the present disclosure. Moreover, it is a matter of course that: the above description indicates a mere example of the present disclosure in every respect; and various improvement and modifications are possible without departing from the scope of the present disclosure. In addition, the embodiments and the examples may partially be replaced with one another and appropriately be combined, and, for example, may be subjected to the below-indicated change.

In other words, a buy/sell order of virtual currency in an electro transaction system 610 may be placed with a dealer for an entity that issues the virtual currency that is a transaction subject instead of or in addition to a virtual currency exchange. The electro transaction system 610 may include respective platforms for buy/sell transactions in the exchange and the dealer. Also, for transfer of a fund, appropriation as a fund, settlement by a fund, transmission of a fund, purchase of, e.g., points using a fund, and transfer of a fund to a financial account, an upper limit of an amount thereof may appropriately be provided or no such upper limit may be provided. Furthermore, when a fund is transferred from a fund transfer account AC2 to a transaction account AC1 to supplement balance insufficiency for payment for buying of virtual currency, if the resulting balance includes a fraction, an amount corresponding to the fraction may be saved in the transaction account AC1, be returned to the fund transfer account AC2 or be managed for the benefit of a provider of the electro transaction system.

### (Supplement Item 1-1)

An information processing method for an information processor (200), the method comprising:

associating a user and a first account (AC1) for the user to sell/buy a transaction subject;

managing a sell/buy order of the transaction subject and a deposit in the first account (AC1);

generating a buy order of the transaction subject based on an instruction from the user; and

if a balance of the deposit has insufficiency for the buy order, transferring a fund that is equal to or exceeds the insufficiency, from one or more second accounts (AC2) that are different from the first account (AC1) and associated with the user to the first account (AC1), based on an approval from the user.

### (Supplement Item 1-2)

The information processing method according to supplement item 1-1, comprising, if the balance of the deposit has no insufficiency for the buy order or the insufficiency of the balance is eliminated, placing the buy order and establishing an agreement of the buy order.

### (Supplement Item 1-3)

The information processing method according to supplement item 1-1 or 1-2, wherein in the step of transferring a fund, the approval from the user is obtained for each buy order to transfer the fund.

### (Supplement Item 1-4)

The information processing method according to any one of supplement items 1-1 to 1-3, wherein in the step of transferring a fund, the fund is transferred based on an approval from the user, the approval being obtained in advance prior to the buy order.

### (Supplement Item 1-5)

The information processing method according to any of supplement items 1-1 to 1-4, comprising, based on an instruction from the user, appropriating proceeds (700) from a particular commercial transaction as a fund in the one or more second accounts (AC2).

### (Supplement Item 1-6)

The information processing method according to any of supplement items 1-1 to 1-5, comprising, based on an instruction from the user, appropriating a money equivalent (800) that is usable for a particular service as a fund in the one or more second accounts (AC2).

### (Supplement Item 1-7)

The information processing method according to any of supplement items 1-1 to 1-6, comprising, based on an instruction from the user, appropriating advance money obtained using a credit card (900) as a fund in the one or more second accounts (AC2).

### (Supplement Item 1-8)

The information processing method according to any of supplement items 1-1 to 1-7, comprising, based on an instruction from the user, appropriating a deposit in the financial account (1000) as a fund in the one or more second accounts (AC2).

### (Supplement Item 1-9)

The information processing method according to any of supplement items 1-1 to 1-8, comprising, based on an instruction from the user, appropriating any one of the proceeds (700) from the particular commercial transaction, the money equivalent (800) that is usable for the particular service, the advance money obtained using the credit card (900) and the deposit in the financial account (1000) or any combination thereof as a fund in the one or more second accounts (AC2).

### (Supplement Item 1-10)

The information processing method according to any of supplement items 1-1 to 1-9, comprising, based on an instruction from the user, using a fund in the one or more second accounts (AC2) for a settlement for a particular commercial transaction or a particular service or transferring the fund in the one or more second accounts (AC2) to an outside.

### (Supplement Item 1-11)

The information processing method according to any of supplement items 1-1 to 1-10, comprising, based on an instruction from the user, purchasing a money equivalent (1200) that is usable for a particular service, using a fund in the one or more second accounts (AC2).

### (Supplement Item 1-12)

The information processing method according to any of supplement items 1-1 to 1-11, comprising, based on an instruction from the user, transferring a fund in the one or more second accounts (AC2) as a deposit to the financial account (1300).

### (Supplement Item 1-13)

The information processing method according to any of supplement items 1-1 to 1-12, wherein in the step of transferring the fund that is equal to or exceeds the balance insufficiency is transferred from the one or more second accounts (AC2) to the first account (AC1) in response to an instruction relating to the buy order from the user.

### (Supplement Item 1-14)

An information processor (200) comprising:

an account management section that associates a user and a first account (AC1) for the user to sell/buy a transaction subject;

a deposit management section that manages a sell/buy order of the transaction subject and a deposit in the first account (AC1);

an order generation section that generates a buy order of the transaction subject based on an instruction from the user; and

a fund transfer section that if a balance of the deposit has insufficiency for the buy order, transfers a fund that is equal to or exceeds the insufficiency, from one or more second accounts (AC2) that are different from the first account (AC1) and associated with the user to the first account (AC1), based on an approval from the user.

### (Supplement Item 1-15)

A program causing an information processor (200) to perform:

associating a user and a first account (AC1) for the user to sell/buy a transaction subject;

managing a sell/buy order of the transaction subject and a deposit in the first account (AC1);

generating a buy order of the transaction subject based on an instruction from the user; and

if a balance of the deposit has insufficiency for the buy order, transferring a fund that is equal to or exceeds the insufficiency, from one or more second accounts (AC2) that are different from the first account (AC1) and associated with the user to the first account (AC1), based on an approval from the user.

### (Supplement Item 2-1)

An information processing method for an information processor (200), the method comprising:

associating a user and a first account (AC1) for the user to buy/sell a transaction subject;

managing a buy/sell order of the transaction subject and a deposit in the first account (AC1); and

transferring a part or all of the deposit from the first account (AC1) to one or more second accounts (AC2) that are different from the first account (AC1) and associated with the user, based on an approval from the user.

### (Supplement Item 2-2)

The information processing method according to supplement item 2-1, comprising:

based on an instruction from the user, generating a sell order of the transaction subject; and

placing the sell order and establishing an agreement of the sell order,

wherein in the step of transferring a part or all of the deposit, a part or all of agreed payment of the sell order is transferred as the deposit.

### (Supplement Item 2-3)

The information processing method according to supplement item 2-2, wherein in the step of generating a sell order, the user generates a sell order of a transaction subject assigned from another user.

### (Supplement Item 2-4)

The information processing method according to supplement item 2-2 or 2-3, wherein in the step of transferring a part or all of the deposit, an approval from the user is obtained for each sell order and a part or all of the deposit is transferred.

### (Supplement Item 2-5)

The information processing method according to supplement item 2-2 or 2-3, wherein in the step of transferring a part or all of the deposit, a part or all of the agreed payment is transferred based on an approval from the user obtained in advance prior to the sell order.

### (Supplement Item 2-6)

The information processing method according to any of supplement items 2-1 to 2-5, wherein in the step of transferring a part or all of the deposit, if a balance of the fund in the one or more fund transfer accounts (AC2) have insufficiency for a predetermined value, a part or all of the deposit is transferred to the one or more fund transfer accounts (AC2).

### (Supplement Item 2-7)

The information processing method according to supplement item 2-6, comprising, based on an instruction from the user, generating a buy order of the transaction subject, wherein in the step of transferring a part or all of the deposit, the predetermined value is a price of the buy order.

### (Supplement Item 2-8)

The information processing method according to any of supplement items 2-1 to 2-7, comprising:

based on an instruction from the user, generating a loan order for obtaining a loan of money using the transaction subject as a mortgage; and placing the loan order and appropriating loaned money as a deposit in the transaction account.

### (Supplement Item 2-9)

An information processor (200) comprising:

an account management section that associates a user and a first account (AC1) for the user to buy/sell a transaction subject;

a deposit management section that manages a buy/sell order of the transaction subject and a deposit in the first account (AC1); and

a deposit transfer section that transfers a part or all of the deposit from the first account (AC1) to one or more second accounts (AC2) that are different from the first account (AC1) and associated with the user, based on an approval from the user.

### (Supplement Item 2-10)

A program for causing an information processor (200) to perform:

associating a user and a first account (AC1) for the user to buy/sell a transaction subject;

managing a buy/sell order of the transaction subject and a deposit in the first account (AC1); and

transferring a part or all of the deposit from the first account (AC1) to one or more second accounts (AC2) that are different from the first account (AC1) and associated with the user, based on an approval from the user.

### (Supplement Item 3-1)

A program for causing an information processing terminal to execute:

displaying a transaction amount designation object with a transaction amount upper limit of a transaction subject as an upper limit of a designation range, the transaction amount upper limit being determined based on a balance of a first account (AC1) and a balance of a second account (AC2);

displaying a transaction amount responding to an instruction for the transaction amount designation object from a user;

if a transaction amount that is smaller than a predetermined transaction amount is designated, displaying only a first display area associated with the first account (AC1); and

if a transaction amount that is larger than the predetermined transaction amount is designated, displaying both the first display area associated with the first account (AC1) and a second display area associated with the second account (AC2).

### (Supplement Item 3-2)

The program according to supplement item 3-1, wherein the predetermined transaction amount is set according to the balance of the first account (AC1).

### (Supplement Item 3-3)

The program according to supplement item 3-1 or 3-2, wherein in the step of, if a transaction amount that is larger than the predetermined transaction amount is designated, displaying both the first display area associated with the first account (AC1) and a second display area associated with the second account (AC2), the first display area is fixedly displayed.

### (Supplement Item 3-4)

The program according to any of supplement items 3-1 to 3-3, further comprising displaying a price based on the transaction amount responding to an instruction for the transaction amount designation object from the user.

### (Supplement Item 3-5)

The program according to any of supplement items 3-1 to 3-4, further comprising displaying a proportion designation object for designating proportions of the first account (AC1) and the second account (AC2) for a transaction of the transaction amount responding to an instruction for the transaction amount designation object from the user.

### (Supplement Item 3-6)

The program according to supplement item 3-5, further comprising displaying a transaction amount associated with the first account (AC1) or the second account (AC2) in response to an instruction for the proportion designation object from the user.

### (Supplement Item 3-7)

The program according to any of supplement items 3-1 to 3-6, wherein the transaction amount upper limit is determined based on the balance of the first account (AC1), the balance of the second account (AC2) and a commission fee required when a transaction is performed.

### (Supplement Item 3-8)

The program according to any of supplement items 3-1 to 3-7, wherein if a price of the transaction amount responding to an instruction for the transaction amount designation object from the user includes a fraction, at least one of the transaction amount designation object and the proportion designation object is displayed so as to respond to the price with the fraction rounded off or the price with the fraction rounded up.

### (Supplement Item 3-9)

The program according to any of supplement items 3-1 to 3-8, further comprising, if a transaction of the transaction amount responding to an instruction for the transaction amount designation object from the user is performed, receiving an instruction relating to an approval from the user.

### (Supplement Item 3-10)

An information processing terminal comprising a display control section,

the display control section providing:

display of a transaction amount designation object with a transaction amount upper limit of a transaction subject as an upper limit of a designation range, the transaction amount upper limit being determined based on a balance of a first account (AC1) and a balance of a second account (AC2);

display of a transaction amount responding to an instruction for the transaction amount designation object from a user;

if a transaction amount that is smaller than a predetermined transaction amount is designated, display of only a first display area associated with the first account (AC1); and

if a transaction amount that is larger than the predetermined transaction amount is designated, display of both the first display area associated with the first account (AC1) and a second display area associated with the second account (AC2).

### (Supplement Item 3-11)

An information processing method for an information processing terminal, the method comprising:

displaying a transaction amount designation object with a transaction amount upper limit of a transaction subject as an upper limit of a designation range, the transaction amount upper limit being determined based on a balance of a first account (AC1) and a balance of a second account (AC2);

displaying a transaction amount responding to an instruction for the transaction amount designation object from a user;

if a transaction amount that is smaller than a predetermined transaction amount is designated, displaying only a first display area associated with the first account (AC1); and

if a transaction amount that is larger than the predetermined transaction amount is designated, displaying both the first display area associated with the first account (AC1) and a second display area associated with the second account (AC2).

### CROSS-REFERENCE TO RELATED APPLICATION

The present application is filed based on Japanese Patent Application No. 2018-134559 filed on Jul. 17, 2018, the disclosure of which is incorporated herein by reference.

What is claimed is:

1. A non-transitory computer-readable medium recording a program for an information processor to perform:
displaying a transaction amount designation object with a transaction amount upper limit of a transaction subject as an upper limit of a designation range, the transaction amount upper limit being determined based on a balance of a first account and a balance of a second account;
displaying a transaction amount responding to an instruction for the transaction amount designation object from a user;
if a transaction amount that is smaller than a predetermined transaction amount is designated, displaying only a first display area associated with the first account; and
if a transaction amount that is larger than the predetermined transaction amount is designated, displaying both the first display area associated with the first account and a second display area associated with the second account.

2. The non-transitory computer-readable medium according to claim 1, wherein the predetermined transaction amount is set according to the balance of the first account.

3. The non-transitory computer-readable medium according to claim 1, wherein in the step of, if a transaction amount that is larger than the predetermined transaction amount is designated, displaying both the first display area associated with the first account and a second display area associated with the second account, the first display area is fixedly displayed.

4. The non-transitory computer-readable medium according to claim 1, further comprising displaying a price based on the transaction amount responding to an instruction for the transaction amount designation object from the user.

5. The non-transitory computer-readable medium according to claim 1, further comprising displaying a proportion designation object for designating proportions of the first account and the second account for a transaction of the transaction amount responding to an instruction for the transaction amount designation object from the user.

6. The non-transitory computer-readable medium according to claim 5, further comprising displaying a transaction amount associated with the first account or the second account in response to an instruction for the proportion designation object from the user.

7. The non-transitory computer-readable medium according to claim 1, wherein the transaction amount upper limit is determined based on the balance of the first account, the balance of the second account and a commission fee required when a transaction is performed.

8. The non-transitory computer-readable medium according to claim 1, wherein if a price of the transaction amount responding to an instruction for the transaction amount designation object from the user includes a fraction, at least one of the transaction amount designation object and the proportion designation object is displayed so as to respond to the price with the fraction rounded off or the price with the fraction rounded up.

9. The non-transitory computer-readable medium according to claim 1, further comprising, if a transaction of the transaction amount responding to an instruction for the transaction amount designation object from the user is performed, receiving an instruction relating to an approval from the user.

10. An information processor comprising a display controller, the display controller providing:
display of a transaction amount designation object with a transaction amount upper limit of a transaction subject as an upper limit of a designation range, the transaction amount upper limit being determined based on a balance of a first account and a balance of a second account;
display of a transaction amount responding to an instruction for the transaction amount designation object from a user;
if a transaction amount that is smaller than a predetermined transaction amount is designated, display of only a first display area associated with the first account; and
if a transaction amount that is larger than the predetermined transaction amount is designated, display of both the first display area associated with the first account and a second display area associated with the second account.

11. An information processing method for an information processor, the method comprising causing an information processor to perform:
displaying a transaction amount designation object with a transaction amount upper limit of a transaction subject as an upper limit of a designation range, the transaction amount upper limit being determined based on a balance of a first account and a balance of a second account;
displaying a transaction amount responding to an instruction for the transaction amount designation object from a user;
if a transaction amount that is smaller than a predetermined transaction amount is designated, displaying only a first display area associated with the first account; and
if a transaction amount that is larger than the predetermined transaction amount is designated, displaying both the first display area associated with the first account and a second display area associated with the second account.
